(19) United States
(12) Patent Application Publication
(10) Pub. No.: US 2009/0316579 A1
(43) Pub. Date: Dec. 24, 2009

(54) Immediate Ready Implementation of Virtually Congestion Free Guaranteed Service Capable Network: External Internet Nextgentcp Nextgenftp Nextgenudps

(76) Inventor: Bob Tang, London (GB)

Correspondence Address: Bob Tang, Flat 82 Eton Hall, Eton College Road, London, NW3 2DH, GB

(21) Appl. No.: 12/223,223

(22) PCT Filed: Feb. 28, 2007
(86) PCT No.: PCT/GB2007/000563

§ 371 Date: Jul. 25, 2008

(30) Foreign Application Priority Data
Feb. 1, 2006 (GB) 0601931.9
Feb. 2, 2006 (GB) 0602027.5
Feb. 15, 2006 (GB) 0602975.5
Feb. 15, 2006 (GB) 0602976.3

(51) Int. Cl. G06F 11/00

(52) U.S. Cl. 370/231

(57) ABSTRACT

Various increment deployable techniques of direct simple source code modifications to TCP/FTP/UDP based protocol stacks & other susceptible protocols, or other related network's switches/routers configurations, are presented for immediate ready implementations over external Internet of virtually congestion free guaranteed service capable network, without requiring use of existing QoS/MPLS techniques nor requiring any of the switches/routers softwares within the network to be modified or contribute to achieving the end-to-end performance results nor requiring provision of unlimited bandwidths at each and every inter-node links within the network.

[NOTE: This invention references whole complete earlier filed related published PCT application WO2005053265 by the same inventor, references whole complete Descriptions (&/or incorporates paragraphs therein where not already included in this application) of unpublished PCT application PCT/IB2005/003580 of 29 Nov. 2005 by the same Inventor]

At present implementations of RSVP/QoS/TAG Switching etc to facilitate multimedia/voice/fax/realtime IP applications on the Internet to ensure Quality of Service suffers from complexities of implementations. Further there are multitude of vendors' implementations such as using ToS (Type of service field in data packet), TAG based, source IP addresses, MPLS etc; at each of the QoS capable routers traversed through the data packets needs to be examined by the switch/router for any of the above vendors' implemented fields (hence need be buffered/queued), before the data packet can be forwarded. Imagined in a terabit link carrying QoS data packets at the maximum transmission rate, the router will thus need to examine (and buffer/queue) each arriving data packets & expend CPU processing time to examine any of the above various fields (eg the QoS priority source IP addresses table itself to be checked against alone may amount to several tens of thousands). Thus the router manufacturer's specified throughput capacity (for forwarding normal data packets) may not be achieved under heavy QoS data packets load, and some QoS packets will suffer severe delays or dropped even though the total data packets loads has not exceeded the link bandwidth or the router manufacturer's specified data packets normal throughput capacity. Also the lack of interoperable standards means that the promised ability of some IP technologies to support these QoS value-added services is not yet fully realised.

Here are described methods to guarantee quality of service for multimedia/voice/fax/realtime etc applications with better or similar end to end reception qualities on the Internet/Proprietary Internet Segment/WAN/LAN, without requiring the switches/routers traversed through by the data packets needing RSVP/Tag Switching/QoS capability, to ensure better Guarantee of Service than existing state of the art QoS implementation. Further the data packets will not necessarily require buffering/queuing for purpose of examinations of any of existing QoS vendors' implementation fields, thus avoiding above mentioned possible drop or delay scenarios, facilitating the switch/router manufacturer's specified full throughput capacity while forwarding these guaranteed service data packets even at link bandwidth's full transmission rates.

### Various Refinements & Notes

### Increment Deployable TCP Friendly External Internet 100% Link Utilisation Data Storage Transfer NextGenTCP:

At the top most level, CWND now never ever gets reduced at all whatsoever.

Its easy to use Windows desktop ‘Folder string search’ facility to locate each & every occurrences of CWND variable in all the sub-folders/files . . . to be thorough on RTO Timedout . . . even if its congestion induced we do not reduce/resets CWND at all . . .
our RTO Timedout algorithm pseudocodes, modifying existing RFC's specifications, would be to (for ‘real congestions drops’ indications):

Timeout: /* Multiplicative decrease */

. recordedCWND = CWND ( BUT IF another RTO
Timeout occurs during a
‘pause ’ in progress THEN recordedCWND =
recordedCWND ! /* doesn't want to erroneously cause
CWND size to be reduced */ )
. ssthresh = cwnd ( BUT IF another RTO Timeout occurs
during a ‘pause ’ in progress THEN SStresh =
recordedCWND ! /* doesn't want to erroneously cause
SSTresh size to be reduced */ ) ;
. calculate ‘ pause ’ interval &sets CWND = ‘ 1 * MSS ’
&restores CWND = recordedCWND after ‘pause ’
counteddown ;

our RTO Timedout algorithm pseudocodes, modifying existing RFC's specifications, would be to (for ‘non-congestion drops’ indications):

Timeout: /* Multiplicative decrease */

ssthresh = sstresh ;
CWND = CWND ;
/* both unchanged ! */

just need ensure RFC's TCP modified complying with these simple rules of thumb:

1. never ever reduces CWND value whatsoever, except to temporarily effect ‘pause’ upon ‘real congestion’ indications (restores CWND to recordedCWND thereafter). Note upon real congestion indications (latest RTT when 3rd DUP ACK or when RTO Timeout−min(RTT)>eg 200 ms) SSTresh needs be set to pre-existing CWND so subsequent CWND increments is additive linear

2. If non-congestion indications (latest RTT when 3rd DUP ACK or when RTO Timedout−min(RTT)<eg 200 ms), for both fast retransmit & RTO Timedout modules do not ‘pause’ & do not allow existing RFCs to change CWND value nor SStresh value at all.

Note current pause’ in progress (which could only have been triggered by ‘real congestions’ indication), if any, should be allowed to progress onto counteddown (for both fast retransmit & RTO Timeout modules).

3. If there is already current ‘pause’ in progress, subsequent intervening ‘real congestion’ indications will now completely terminates current ‘pause’ & begin a new ‘pause’ (a matter of merely setting/overwriting a new ‘pause’ countdown value): taking care that for both fast retransmit & RTO Timeout modules recordedCWND now=recordedCWND (instead of =CWND) & now SStresh=recordedCWND (instead of CWND)

### Very Simple Basic Working 1st Version Complete Specifications: Only Few Lines Very Simple FreeBSD/Linux TCP Source Code Modifications

[Initially needs sets very large initialised min(RTT) value=eg 30,000 ms, then continuously set min(RTT)=min (latest arriving ACK's RTT, min(RTT))]

1.1 IF 3rd DUP ACK THEN

IF RTT of latest returning ACK when 3 DUP ACKs fast

retransmission − current recorded min(RTT) = < eg 200 ms ( ie
we know now this packet drop couldn't possibly be caused by ′
congestion event′ , thus should not unnecessarily set SStresh to
CWND value ) THEN do not change CWND / SSTresh value ( ie
to not even set CWND = CWND/2 nor SSthrsh to CWND/ 2 , as
presently done in existing fast retransmit RFCs )

ELSE should set SSThresh to be same as this recorded existing

CWND size ( instead of to CWND/2 as in existing Fast
Retransmit RFCs ), AND to instead keeps a record of existing
CWND size & set CWND = ‘ 1 * MSS ’ & set a ′ pause

′ countdown global variable = minimum of ( latest RTT of

packet triggering the 3rd DUP ACK fast retransmit or triggering
RTO Timeout − min(RTT) . 300ms )
Note : setting CWND value = 1 * MSS , would cause the
desired temporary
pause/halt of all forwarding onwards of packets , except the very
1st fast retransmit packet retransmission packet/s, to allow
buffered packets along the path to be cleared ‘ before TCP
resumes sending ]

ENDIF

ENDIF

1.2 after ‘pause’ time variable counted down, restores CWND to recorded previous CWND value (ie sender can now resumes normal sending after ‘pause’ over)

2.1 IF RTO Timeout THEN

IF RTT of latest returning ACK when RTO Timedout −

current recorded min(RTT) = < eg 200 ms ( ie we know now this
packet drop couldn't possibly be caused by ′ congestion event′ ,
thus should not unnecessarily reset CWND value to 1 * MSS )
THEN do not reset CWND value to 1 * MSS nor changes
CWND value at all ( ie to not even resets CWND at all , as
presently done in existing RTO Timeout RFCs )

ELSE should instead keeps a record of existing CWND

size & set CWND = ‘ 1 * MSS ’ & set a ′ pause ′ countdown
global variable = minimum of ( latest RTT of packet when RTO
Timedout − min(RTT) , 300ms )
Note : setting CWND value = 1 * MSS , would cause the
desired temporary pause/halt of all forwarding onwards of
packets , except the RTO Timedout retransmission packet/s , to
allow buffered packets along the path to be cleared ‘
before TCP resumes sending ]

2.2 after ‘pause’ time variable counted down, restores CWND to recorded previous CWND value (ie sender can now resumes normal sending after ‘pause’ over)

THAT'S ALL, DONE NOW!

### Background Materials

latest RTT of packet triggering the 3rd DUP ACK fast retransmit or triggering RTO Timeout, is readily available from existing Linux TCB maintained variable on last measured roundtrip time RTT. the minimum recorded min(RTT) is only readily available from existing Westwood/FastTCP/Vegas TCB maintained variables, but should be easy enough to write few lines of codes to continuously update min(RTT)=minimum of [min(RTT), last measured roundtrip time RTT] References http://www.cs.umd.edu/˜shankar/417-Notes/5-note-transportCongControl.htm: RTT variables maintained by Linux TCB<http://www.scit.wlv.ac.uk/rfc/rfc29xx/RFC2988.html>: RTO computation Google Search term ‘tcp rtt variables’<http://www.psc.edu/networking/perf_tune.html>: tuning Linux TCP RTT parameters Google Search: ‘linux TCP minimum recorded RTT’ or ‘linux tcp minimum recorded rtt variable’. NOTE: TCP Westwood measures minimum RTT

### Notes:

1. The above ‘congestion notification trigger events’, may alternatively be defined as when latest RTT−min(RTT)>=specified interval eg 5 ms/50/300 ms . . . etc (corresponding to delays introduced by buffering experienced along the path over & beyond pure uncongested RTT or its estimate min(RTT), instead of packet drops indication event.

2. Once the ‘pause’ has counteddown, triggered by real congestion drop/s indications, above algorithms/schemes may be adapted so that CWND is now set to a value equal to the total outstanding in-flight-packets at this instantaneous ‘pause’ counteddown time (ie equal to latest largest forwarded SeqNo−latest

largest returning ACKNo)==>this would prevent a sudden large burst of packets being generated by source TCP, since during ‘pause’period’ there could be many returning ACKs received which could have very substantially advanced the Sliding Window's edge.

Also as an alternative example among many possible, CWND could initially upon the 3^{rd} DUP ACK fast retransmit request triggering ‘pause’ countdown be set to either unchanged CWND (instead of to ‘1*MSS’) or to a value equal to the total outstanding in-flight-packets at this very instance in time, and further be restored to a value equal to this instantaneous total outstanding in-flight-packets when ‘pause’ has counteddown [optionally MINUS the total number additional same SeqNo multiple DUP ACKS (beyond the initial 3 DUP ACKS triggering fast retransmit) received before ‘pause’ counteddown at this instantaneous ‘pause’ counteddown time (ie equal to latest largest forwarded SeqNo−latest largest returning ACKNo at this very instant in time)]→modified TCP could now stroke out a new packet into the network corresponding to each additional multiple same SeqNo DUP ACKs received during ‘pause’ interval, & after ‘pause’ counteddown could optionally belatedly ‘slow down’ transmit rates to clear intervening bufferings along the path IF CWND now restored to a value equal to the now instantaneous total outstanding in-flight-packets MINUS the total number additional same SeqNo multiple DUP ACKS received during ‘pause’, when ‘pause’has counteddown.

Another possible example is for CWND initially upon the 3^{rd} DUP ACK fast retransmit request triggering ‘pause’ countdown be set to ‘1*MSS’, and then be restored to a value equal to this instantaneous total outstanding in-flight-packets MINUS the total number additional same SeqNo multiple DUP ACKS when ‘pause’ has counteddown→this way when ‘pause’ counteddown modified TCP will not ‘burst’ out new packets but to only start stroking out new packets into network corresponding to subsequent new returning ACK rates

3. The above algorithm/scheme's ‘pause’ countdown global variable=minimum of (latest RTT of packet triggering the 3rd DUP ACK fast retransmit or triggering RTO Timeout−min(RTT), 300 ms) above, may instead be set=minimum of (latest RTT of packet triggering the 3rd DUP ACK fast retransmit or triggering RTO Timeout−min(RTT), 300 ms, max(RTT)), where max(RTT) is the largest RTT observed so far. Inclusion of this max(RTT) is to ensure even in very very rare unlikely circumstance where the nodes' buffer capacity are extremely small (eg in a LAN or even WAN, the ‘pause’ period will not be unnecessarily set to be too large like eg the specified 300 ms value. Also instead of above example 300 ms, the value may instead be algorithmically derived dynamically for each different paths.

4. A simple method to enable easy widespread implementation of ready guaranteed service capable network (or just congestion drops free network, &/or just network with much much less buffering delays), would be for all (or almost all) routers & switches at a node in the network to be modified/software upgraded to immediately generate total of 3 DUP ACKs to the traversing TCP flows' sources to indicate to the sources to reduce their transmit rates when the node starts to buffer the traversing TCP flows' packets (ie forwarding link now is 100% utilised & the aggregate traversing TCP flows' sources' packets start to be buffered). The 3 DUP ACKs generation may alternatively be triggered eg when the forwarding link reaches a specified utilisation level eg 95%/98% . . . etc, or some other trigger conditions specified. It doesn't matter even if the packet corresponding to the 3 pseudo DUP ACKs are actually received correctly at the destinations, as subsequent ACKs from destination to source will remedy this.

The generated 3 DUP ACKs packet's fields contain the minimum required source & destination addresses & SeqNo (which could be readily obtained by

inspecting the packet/s that are now presently being buffered, taking care that the 3 pseudo DUP ACKs' ACK field is obtained/or derived from the inspected buffered packet's ACKNo). Whereas the pseudo 3 DUP ACKs' ACKNo field could be obtained/or derived from eg switches/routers' maintained table of latest largest ACKNo generated by destination TCP for particular the unidirectional source/destination TCP flow/s, or alternatively the switches/routers may first wait for a destination to source packet to arrive at the node to then obtain/or derive the 3 pseudo DUP ACKs' ACKNo field from inspecting the returning packet's ACK field.

Similarly to above schemes, existing RED & ECN . . . etc could similarly have the algorithm modified as outlined above, enabling real time guaranteed service capable networks (or non congestion drops, &/or much much less buffer delays networks).

5. Another variant implementation on windows:

first needs the module taking over all fast retransmit/RTO Timeout from MSTCP, ie MSTCP never ever sees any DUP ACKs nor RTO Timeout: the module will simply spoof acked every intercepted new packets from MSTCP (ONLY LATER: & where required send MSTCP ‘0’ window size update, or modify incoming network packets'

window size field to ‘0’, to pause/slow down MSTCP packets generations: upon congestion notifications eg 3 DUP ACKs or RTO Timeout). Module builds a list of SeqNo/packet

copy/systime of all packets forwarded (well ordered in SeqNo) & do fast retransmit/RTO retransmit from this list. All items on list with SeqNo<current largest received ACK will be removed, also removed are all SeqNos SACKed.

Remember needs incorporate ‘SeqNo wraparound’ & ‘time wraparound’ protections in this module.

By spoofing acks all intercepted MSTCP outgoing packets, our windows software now doesn't need to alter any incoming network packets to MSTCP at all whatsoever . . . MSTCP will simply ignore all 3 DUP ACKs received since they are now already outside of the sliding window (being already acked !), nor will sent packets ever timedout (being already acked !)

further we can now easily control MSTCP packets generation rates at all times, via receiver window size fields changes . . . etc. Software could emulate MSTCP own Windows increment/Congestion Control/AIMD mechanisms, by allowing at any time a maximum of packets-in-flights equal to emulated/tracked MSTCP's CWND size: as an overview outline example (among many possible), this could be achieved eg assuming for each returning ACKs emulated/tracked pseudo-mirror CWND size is doubled in each RTT when there has not been any 3 DUP ACK fast retransmit, but once this has occurred emulated/tracked pseudo-mirror CWND size would only now be incremented by 1*MSS per RTT. Software would only ever allows a maximum of instantaneous total outstanding in-flight-packets not more than the emulated/tracked pseudo CWND size, & to throttle MSTCP packets generations via receiver window size update of ‘0’/modifying incoming packets' receiver window size to ‘0’ to ‘pause’ MSTCP transmissions when the pseudo-CWND size is exceeded.

This Window software could then keeps track of or estimate the MSTCP CWND size at all times, by tracking latest largest forwarded onwards MSTCP packets' SeqNo & latest largest network's incoming packets' ACKNo (their difference gives the total in-flight-packets outstanding, which correspond to MSTCP's CWND value quite very well). Window Software here just needs make sure it would stop ‘automatic spoof ACKs’ to MSTCP once total number of in-flight-packets>=above mentioned CWND estimate (or alternatively effective window size derived from above CWND estimate & RWND &/or SWND)

### 20 Dec. 2005 Filing

### Various Refinements & Notes

Various refinements &/or adaptations to implementing earlier described methods could easily be devised, yet coming under the scope & principles earlier disclosed.

With Intercept Module (eg using Windows' NDIS or Registry Hooking, or eg IPChain in Linux/FreeBSD . . . etc), an TCP protocol modification implementation was earlier described which emulates & takes over complete responsibilities of fast retransmission & RTO Timeout retransmission from unmodified TCP itself totally, which necessitates the Intercept Module to include codes to handle complex recordations of Sliding Window's worth of sent packets/fast retransmissions/RTO retransmissions . . . etc. Here is further described an improved TCP protocol modification implementation which does not require Intercept Module to take over complete responsibilities of fast retransmission & RTO Timeout retransmission from unmodified TCP itself:
1 Intercept Module first needs to dynamically track the TCP's CWND size ie total in-flights-bytes (or alternatively in units of in-flights-packets), this can be achieved by tracking the latest largest SentSeqNo−latest largest ReceivedACKNo:
   immediately after TCP connection handshake established, Intercept Module records the SentSeqNo of the 1^{st} packet sent & largest SentSeqNo subsequently sent prior to when ACKnowledgement for this 1^{st} packet's SentSeqNo is received back (taking one RTT variable time period), the largest SentSeqNo−the 1^{st} packet's SentSeqNo now gives the flow's tracked TCP's dynamical CWND size during this particular RTT period. The next subsequent newly generated sent packet's SentSeqNo will now be noted (as marker for the next RTT period) as well as the largest SentSeqNo subsequently sent prior to when ACKnowledgement for this next marker packet's SentSeqNo is received back, the largest SentSeqNo−this next marker packet's SentSeqNo now gives the flow's tracked TCP's dynamical CWND size during this next RTT period. Obviously a marker packet's could be acknowledged by a returning ACK with ACKNo>the marker packet's SentSeqNo, &/or can be further deemed/treated to be ‘acknowledged’ if TCP RTO Timedout retransmit this particular marker packet's SentSeqNo again. This process is repeated again & again to track TCP's dynamic CWND value during each successive RTTs throughout the flow's lifetime, & an update record is kept of the largestCWND attained thus far (this is useful since Intercept Module could now help ensure there is only at most largestCWND amount of in-flights-bytes (or alternatively in units of in-flights-packets, at any one time). Note there are also various other pre-existing methods which tracks CWND value passively, which could be utilised.
2 When there is a returning 3^{rd} DUP ACK packet intercepted by Intercept Module, Intercept Module notes this 3^{rd} DUP ACK's FastRtmxACKNo & the total in-flights-bytes (or alternative in units of in-flights-packets) at this instant to update largestCWND value if required. During this duration when TCP enters into fast retransmit recovery phase, Intercept Module notes all subsequent same ACKNo returning multiple DUP ACKs (ie the rate of returning ACKs) & records MultACKbytes the total number of bytes (or alternatively in units of packets) representing the total data payload sizes (ignoring other packet headers . . . etc) of all the returning same ACKNo multiple DUP, before TCP exits the particular fast retransmit recovery phase (such as when eg Intercept Module next detects returning network packet with incremented ACKNo). In the alternative MultACKbytes may be computed from the total number of bytes (or alternatively in units of packets) representing the total data payload sizes (ignoring other packet headers . . . etc) of all the fast retransmitted packets DUP, before TCP exits the particular fast retransmit recovery phase . . . or some other devised algorithm calculations. Existing RFCs TCPs during fast retransmit recovery phase usually halved CWND value+fast retransmit the requested 1^{st} fast retransmit packet+wait for CWND size sufficiently incremented by each additional subsequent returning same ACKNo multiple DUP ACKs to then retransmit additional enqueued fast retransmit requested packet/s.

TCP is modified such that CWND never ever gets decremented regardless, & when 3^{rd} DUP ACK request fast retransmit modified TCP may (if desired, as specified in existing RFC) immediately forward onwards the very 1^{st} fast retransmit packet regardless of Sliding Window mechanism's constraints whatsoever, & then only allow fast retransmit packets enqueued (eg generated according to SACK ‘missing gaps’ indicated) to be forwarded onwards ONLY one at a time in response to each subsequent arriving same ACKNo multiple DUP ACKs (or alternatively a corresponding number of bytes in the fast retransmit packet queue, in response to the number of bytes ‘freed up’ by the subsequent arriving same ACKNo multiple DUP ACKs). When the fast retransmit recovery is exited (such as the returning network packet's ACKNo is now incremented, different from earlier 3^{rd} or further multiple DUP ACKNos), this will be the ONLY EXCEPTION CIRCUMSTANCE EVER whereby CWND would now be decremented by the number of bytes forwarded onwards from the fast retransmit packets queue (or decremented by the number of bytes ‘freed up’ by the subsequent arriving same ACKNo multiple DUP ACKs)→upon exiting fast retransmit recovery phase, modified TCP will not suddenly ‘surge’ out a burst of packets into network (due to eg the single returning network packet's ACKNo now acknowledges an exceptionally large number of received packets), & it is this very appropriate reduction of CWND value that does the better congestion control/avoidance mechanism more efficiently than existing RFCs. Similarly during RTO Timeout retransmissions, CWND is never decremented under any circumstances ever without any exceptions. Note during fast retransmit recovery phase, modified TCP ‘strokes’ out fast retransmit packets (&/or with lesser priority normal TCP generated packets queue if any) only in accordance/allowed by the rates of the returning ACKs.

Example: without Requiring Intercept Module Implementing Fast Retransmit/RTO Timeout Retransmit:
Intercept Module tracks largest observed CWND (ie total in-flights-bytes/packets)
on 3^{rd} DUP ACK, Intercept Module follows with generation of multiple same ACKNo DUP ACKs, exact number of these could be eg such that it is a largest possible integer number*remote sender's TCP's SMSS=<total in-flight-bytes at the instant of the initial 3^{rd} DUP ACK triggering fast retransmit request being forwarded to resident RFC's TCP (note SMSS is the negotiated sender maximum segment size, which should have been ‘recorded’ by Receiver Side Intercept Software during the 3-way handshake TCP establishment stage, since existing RFC TCPs reduces CWND to CWND/2 on 3^{rd} DUP ACK fast retransmit request, to restore CWND size to be unhalved. TCP itself should now fast retransmit the 1^{st} requested packet, & only ‘stroke’ out any subsequent enqueued fast retransmit requested packets only at the same rate as the returning same ACKNo multiple DUP ACKS.
On TCP exiting fast retransmit recovery phase, Intercept Module again generates ACK divisions to inflate CWND back to unhalved value (note on exiting fast retransmit recovery phase TCP sets CWND to stored value of CWND/2)

see http://www.cs.toronto.edu/syslab/courses/csc2231/05au/reviews/HTML/09/0007.html
similarly on RTO Timedout retransmit, Intercept Module could generate ACK divisions to inflate CWND back to same value (note on RTO Timedout retransmit TCP resets CWND to 1*SMSS)

### January 2006 Filing

### Various Refinements & Notes

“ . . . where all Receiver TCPs in the network are all thus modified as described above, Receiver TCPs could have complete control of the sender TCPs transmission rates via its total complete control of the same SeqNo series of multiple DUP ACKs generation rates/spacings/temporary halts . . . etc according to desired algorithms devised . . . eg multiplicative increase &/or linear increase of multiple DUP ACKs rates every RTT (or OTT) so long as RTT (or OTT) remains equal to or less than current latest recorded min(RTT) (or current latest recorded min(OTT))+variance (eg 10 ms to allow for eg Windows OS non-real time characteristics) . . . etc. . . . ”

Improvements were added/inserted (underlined):

“ . . . [NOTE COULD ALSO INSTEAD OF PAUSING OR VARIOUS EARLIER CWND SIZE SETTING FORMULA, TO JUST SET CWND TO APPROPRIATE CORRESPONDING ALGORITHMICALLY DETERMINED VALUE/S ! such as reducing CWND size (or in cases of closed proprietary source TCPs where CWND could not be directly modified, the value of largest SentSeqNo+its data payload length−largest ReceivedACKNo ie total in-flights-bytes (or in-flight-packets) must instead be ensured to be reduced accordingly eg by enqueing newly generated packets from MSTCP instead of forwarding them immediately) by factor of {latest RTT value (or OTT where appropriate)−recorded min(RTT) value (or min(OTT) where appropriate)}/min (RTT), OR reducing CWND size by factor of [{latest RTT value (or OTT where appropriate)−recorded min(RTT) value (or min(OTT) where appropriate)}/latest RTT value], OR setting CWND size (&/or ensuring total in-flight-bytes) to CWND (&/or total in-flight-bytes)*[1,000 ms/1,000 ms+{latest RTT value (or OTT where appropriate)−recorded min(RTT) value (or min(OTT) where appropriate)}] . . . etc ie CWND now set to CWND*[1−[{latest RTT value (or OTT where appropriate)−recorded min(RTT) value (or min(OTT) where appropriate)}/latest RTT value]], OR setting CWND size to CWND*min(RTT) (or min(OTT) where appropriate)/latest RTT value (or OTT where appropriate), OR setting CWND size (&/or ensuring total in-flight-bytes) to CWND (&/or total in-flight-bytes)*[1,000 ms/1,000 ms+{latest RTT value (or OTT where appropriate)−recorded min(RTT) value (or min(OTT) where appropriate)} . . . etc depending on desired algorithm devised]. Note min (RTT) being most current estimate of uncongested RTT of the path recorded,”

Above latest RTT value (or OTT where appropriate), recorded min(RTT) value (or min(OTT) where appropriate), CWND size, total in-flight-bytes . . . etc refers to their recorded value/s as at the very moment of 3^{rd} DUP ACK fast retransmit request or at the very moment of RTO Timeout. Also instead & in place of effecting ‘pause’ in any of the earlier described methods/sub-component methods, the method/sub-component methods described may set CWND size (&/or ensuring total in-flight-bytes) to CWND (or total in-flight-bytes)*[1,000 ms/1,000 ms+{latest RTT value (or OTT where appropriate)−recorded min(RTT) value (or min(OTT) where appropriate)}]

It should be noted here 1 second is always the bottleneck link's equivalent bandwidth, & the latest Total In-flight-Bytes' equivalent in milliseconds is 1,000 ms+(latest returning 3^{rd} DUP ACK's RTT value or RTO Timedout value−min(RTT))→Total number of In-flight-Bytes' as at the time of 3^{rd} DUP ACK or as at the time of RTO Timeout*1,000 ms/{1,000 ms+(latest returning 3^{rd} DUP ACK's RTT value or RTO Timedout value−min(RTT))} equates to the correct amount of in-flight-bytes which would now maintain 100% bottleneck link's bandwidth utilisation (assuming all flows are modified TCP flows which all now reduce their CWND size &/or all now ensure their total number of in-flight-bytes are now reduced accordingly, upon exiting fast retransmit recovery phase or upon RTO Timedout. During fast retransmit recovery phase, modified TCP may optionally after the initial 1^{st} fast retransmit packet is forwarded (this 1^{st} fast retransmit packet is always forwarded immediately regardless of Sliding Window constraints, as in existing RFCs) to ensure only 1 fast retransmit packet is ‘stroked’ out for every one returning ACK (or where sufficient cumulative bytes are freed by returning ACK/s to ‘stroke’ out the fast retransmit packet)

Note: other examples implementation of NextGenTCP could just:

1. modified TCP basically always at all times ‘stroke’ out a new packet only when an ACK returns (or when returning ACK/s cumulatively frees up sufficient bytes in Sliding Window to allow this new packet to be sent), unless CWND incremented to inject ‘extra’ in-flight-packets as in existing RFC's AIMD, or in accordance with some other designed CWND size &/or total in-flight-bytes increment/decrement mechanism algorithms.

Note ‘stroking’ out a new packet for every one of the returning ACKs (or when returning ACK/s cumulatively frees up sufficient bytes in Sliding Window to allow this new packet to be sent) will only generate a new packet to take the place of the ACKed packet which has now left the network, maintaining only the same present total amount of In-Flight-Bytes. Further if returning ACK's RTT is ‘uncongested’ ie if latest returning ACK's RTT=<min(RTT)+var (eg 10 ms to allow for Windows OS non-real time characteristics) then could increment present Total-In-Flight-Bytes by 1 packet's worth, in addition to the ‘basic’ stroking one out for every one returning ACK==>equivalent to Exponential Increase (can further be usefully adapted to eg one tenth increment per RTT eg increment inject 1 ‘extra’ packet for every 10 returning ACKs with uncongested RTTs).

2. Optionally either way, TCP never increases CWND size &/or ensures increase of total in-flight-bytes (exponential or linear increments) OR increases in accordance with specified designed algorithm (eg as described in immediate paragraph above) IF returning RTT<min(RTT)+var (eg 10 ms to allow for Windows OS non-real time characteristics), ELSE do not increment CWND &/or total in-flight-bytes whatsoever OR increment only in accordance with another specified designed algorithm (eg linear increment of 1*SMSS per RTT if all this RTT's packets are all acked).
1. Optional but much prefers, sets CWND &/or ensure total in-flight-bytes sets to recorded MaxUncongestedCWND immediately upon exiting fast retransmit recovery (ie an ACK now arrives back for a SeqNo sent after the 3rd DUP ACK triggering present fast retransmit) or upon RTO Timeout.

MaxUncongestedCWND, ie the maximum size of in-flight-bytes (or packets) during ‘uncongested’ periods, could be tracked/recorded as follows, note here total in-flight-bytes is different/not always same as CWND size (this is the traffics ‘quota’ secured by this particular TCP flow under total continuously ‘uncongested’ RTT periods):

Initialise min(RTT) to very large eg 3,000,000 ms

Initialise MaxUncongestedCWND to 0

check each returning ACK's RTT:

IF RTT<recorded min(RTT) THEN min(RTT)=RTT

IF RTT=<min(RTT)+variance THEN

IF (present LargestSentSeqNo+datalength)−present

LargestACKNo (ie total amount of in-flight-bytes)>recorded

MaxUncongestedCWND (must be for eg at least 3 consecutive RTT periods &/or at least for eg 500 ms period)

THEN recorded MaxUncongestedCWND=present LargestSentSeqNo+datalength−present LargestACKNo/*ie update CWND to the increased total number of in-flight-bytes, which must have endured for eg at least 3 consecutive RTT periods &/or at least for eg 500 ms period: this to ensure the increase is not due to ‘spurious’ fluctuations)*/

Instead of having to track MaxUncongestedCWND & reset CWND size &/or total in-flight-bytes to MaxUncongestedCWND, we could instead just update record maximum of total in-flight-bytes (ie maximum largest SentSeqNo+datalength−largest ReceivedACKNo, which must have endured for eg at least 3 consecutive RTT periods &/or at least for eg 500 ms period) & ensure total in-flight-bytes is reset to eg {maximum largest SentSeqNo+datalength−largest ReceivedACKNo}*{1,000 ms/(1,000 ms+(latest returning ACK's RTT−latest recorded min(RTT))} . . . etc.

NextGenTCP/NextGenFTP now basically ‘stroke’ out packets in accordance with the returning ACK rates ie feedback from ‘real world’ networks. NextGenTCP/NextGenFTP may now specify/designed various CWND increment algorithm &/or total in-flight-bytes/packets constraints: eg based at least in part on latest returning ACKs RTT (whether within min(RTT)+eg 10 ms variance, or not), &/or current value of CWND &/or total in-flight-bytes/packets, &/or current value of MaxUncongestedCWND, &/or pastTCP states transitions details, &/or ascertained bottleneck link's bandwidth, &/or ascertained path's actual real physical uncongested RTT/OTT or min(RTT)/min(OTT), &/or Max Window sizes, &/or ascertained network conditions such as eg ascertained number of TCP flows traversing the ‘bottleneck’ link &/or buffer sizes of the nodes along the path &/or utilisation levels of the link/s along the path, &/or ascertained user application types &/or ascertained file size to be transferred . . . or combination subsets thereof.

Eg when latest returning ACK is considered ‘uncongested’, & NextGenTCP/NextGenFTP has already previously experienced ‘packet drop/s event’, the increment algorithm injecting new extra packets into network may now increment CWND &/or total in-flight-bytes by eg 1 ‘extra’ packet for every 10 returning ACKs received (or increment by eg 1/10^{th} of the cumulative bytes freed up by returning ACKs), INSTEAD of eg exponential increments prior to the 1^{st}’ packet drop/s event occurring . . . there are many many useful increment algorithms possible for different user application requirements.

This Intercept Software is based on implementing stand-alone fast retransmit &RTO Timeout retransmit module (taking over all retransmission tasks from MSTCP totally). This module takes over all 3DUP ACK fast retransmit & RTO Timeout responsibility from MSTCP, MSTCP will not ever encounter any 3^{rd} DUP ACK fast retransmit request nor experience any RTO Timeout event (an illustrative situation where this can be so is eg Intercept Software immediately ‘spoof acks’ to MSTCP whenever receiving new SeqNo packet/s from MSTCP: here MSTCP will exponentially increment its CWND until it reaches MIN [negotiated Max Receiver Window Size, negotiated Max Sender Window Size] & stays at this size continuously, Intercept Software could eg now just ‘immediately spoof ACKs’ to MSTCP so long as the total in-flights-packets (=LargestRecordedSentSeqNo−LargestRecordedACKNo)<MIN [advertised Receiver Window Size, negotiated Max Sender Window Size, CWND] or even some specified algorithmically derived size). By spoofing acks of all intercepted MSTCP outgoing packets, Intercept Software now doesn't need to alter any incoming network packet/s' fields value/s to MSTCP at all whatsoever . . . MSTCP will simply ignore all 3 DUP ACKs received since they are now already outside of the sliding window (being already acked !), nor will sent packets ever timedout (being already acked !). Further Intercept Software can now easily control MSTCP packets generation rates at all times, via receiver window size fields changes, ‘spoof acks’ . . . etc.

Some examples of fast retransmit policy considerations (Rule of Thumbs):

1. should cover fast retransmit with SACK feature enabled

2. Old Reno RFC specifies only one packet to be immediately retransmitted upon initial 3rd DUP ACK regardless of Sliding Window/CWND constraint), WHEREAS NewReno with SACK feature RFC specifies one packet to be immediately retransmitted upon initial 3rd DUP ACK (regardless of Sliding Window/CWND constraint)+halving CWND+increment halved CWND by one MSS for each subsequent same SeqNo multiple DUP ACKs to enable possibly more than one fast retransmission packet per RTT (subject to Sliding Window/CWND constraints)

An example Fast Retransmit Policy (FOR OUTLINE PURPOSES ONLY):
(a) one packet to be immediately retransmitted upon initial 3rd DUP ACK (regardless of Sliding Window/CWND/‘Pause’ constraint, since we don't have access to Sliding Window/CWND any way !)
(b) Any retransmission packets enqueued (as possibly indicated by SACK ‘gaps’) will be stroked out one at a time, corresponding to each one of the returning same SeqNo multiple DUP ACKs (or preferably where the returning same SeqNo multiple DUP ACKS' total byte counts permits . . . ). Any enqueued retransmission packets will be removed if SACKed by a returning same SeqNo multiple DUP ACKs (since acknowledged receipt). On returning ACKNo incremented, we can simply let these enqueued retransmission packets be priority stroked out one at a time, corresponding to each one of the returning normal ACKs (LATER: OPTIONALLY we can instead simply discard all enqueued retransmission packets, & start anew as in (a) above).

Some examples of the features which may be required in the Intercept Software:

1 Track SACK—remove SACKed entries from packet copies list (entries here also removed whenever ACKed): an easy implementation could be for every multiple DUP ACKS during fast retransmit recovery phase, if SACK flagged THEN remove all SACKed packet copies & remove all SACKed Fast Retransmit packets enqueued:

ie upon initial 3rd DUP ACK first note the pointer position of the present last packet copy entry & fast retransmit the requested 1st packet regardless, remove SACKed packet copies, enqueue all packet copies up to the noted present last packet copy in Fast Retransmit Queue, THEN for every subsequent multiple DUP ACKs first remove all SACKed entries in packet copies & Fast Retransmit Queue & ‘stroke’ out one enqueue fast retransmit packet (if any) for every returning multiple DUP ACK (or where returning multiple DUP ACK/s cumulatively frees up sufficient bytes).

Upon exiting fast retransmit recovery, discard the Fast Retransmit Queue but do not remove entries in the packet copies list.

3. Reassemble fragmented IP datagrams

4. Standard RTO calculation—RTO Timeout Retransmission calculations includes successive Exponential Backoff when same segment timeouted again, includes RTO min flooring 1 second, Not includes DUP/fast retransmit packet's RTT in RTO calculations (Karn's algorithm)

5. If RTO Timeouted during fast retransmit recovery phase==>exit fast retransmit recovery ie follows RFC's specification)

6. When TCPAcceleration.exe acking in the other direction with same SeqNo & no data payload (rare)==>needs handling (ie if ACK in the other direction has no data payload, just forward & needs not add to packet copies list.)

7. local system Time Wrapround protection (eg at midnight) & SeqNo wrapround protection whenever codes involve SeqNo comparisons.

To ensure Intercept Module only ever forward total number of in-flights-bytes=<MSTCP's CWND size==>needs to ‘passive track’ CWND size (eg generate SWND Update of ‘0’ immediately & set all incoming packet's SWND to ‘0’ during the required time, so MSTCP refrains from generating new packets. Note all received MSTCP packets continue to be ‘immediately spoof acked’ regardless, its the ‘0’ sender window size update that cause MSTCP to refrain):

“Intercept Module first needs to dynamically track the TCP's CWND size ie total in-flights-bytes (or alternatively in units of in-flights-packets), this can be achieved by tracking the latest largest SentSeqNo−latest largest ReceivedACKNo:
immediately after TCP connection handshake established, Intercept Module records the SentSeqNo of the 1st packet sent & largest SentSeqNo subsequently sent prior to when ACKnowledgement for this 1st packet's SentSeqNo is received back (taking one RTT variable time period), the largest SentSeqNo−the 1st packet's SentSeqNo now gives the flow's tracked TCP's dynamical CWND size during this particular RTT period. The next subsequent newly generated sent packet's SentSeqNo will now be noted (as marker for the next RTT period) as well as the largest SentSeqNo subsequently sent prior to when ACKnowledgement for this next marker packet's SentSeqNo is received back, the largest SentSeqNo−this next marker packet's SentSeqNo now gives the flow's tracked TCP's dynamical CWND size during this next RTT period. Obviously a marker packet's could be acknowledged by a returning ACK with ACKNo>the marker packet's SentSeqNo, &/or can be further deemed/treated to be ‘acknowledged’ if TCP RTO Timedout retransmit this particular marker packet's SentSeqNo again. This process is repeated again & again to track TCP's dynamic CWND value during each successive RTTs throughout the flow's lifetime, & an update record is kept of the largestCWND attained thus far (this is useful since Intercept Module could now help ensure there is only at most largestCWND amount of in-flights-bytes (or alternatively in units of in-flights-packets, at any one time). Note there are also various other pre-existing methods which tracks CWND value passively, which could be utilised.”

At sender TCP, estimate of CWND or actual in Flights can very easily be derived from latest largest SentSeqNo−latest largest ReceivedACKNo

Another example implementation outline improving the above:
Intercept Software should now ONLY ‘spoof next ack’ when it receives 3rd DUP ACKs (ie it first generates the next ack to this particular 3rd DUP packet's ACKNo (look up the next packet copies' SeqNo, or set spoofed ack's ACNo to 3^{rd} DUP ACK's SeqNo+DataLength), before forwarding onwards this 3rd DUP packet to MSTCP & does retransmit from the packet copies), or ‘spoof next ack’ to the RTO Timedout's SeqNo (look up the next packet copies' SeqNo, or set spoofed ack's ACNo to 3^{rd} DUP ACK's SeqNo+DataLength) if eg 850 ms expired since receiving the packet from MSTCP (to avoid MSTCP timeout after 1 second). This way Intercept Software does not within few milliseconds immediately upon TCP connection cause CWND to reach max window size. Intercept Software now never ‘immediately’ spoof acks.

/*now should really generate spoofed ACKNo>the 3rd DUP ACKNo, to pre-empt fast retransmit being triggered)*/
With this Corrections there is no longer any need at all to generate ‘0’ sender window updates nor set any incoming packet's SWND to ‘0’, since Intercept Software no longer indiscriminately ‘spoof acks’

With this Corrections there is also no longer any need at all to ‘passive track’ CWND size.

Intercept Software should upon 3rd DUP ACK immediately generate the 1st retransmit packet requested, (if SACK option) enqueue other indicated SACK ‘gap’ packets & forward one of these for each returning ACK during fast retransmit recovery (or alternatively if returning ACK frees up sufficient bytes): BUT now should simply just ‘discard’ any enqueued packets here immediately upon exiting fast retransmit recovery phase (ie when an ACK now arrives for a SeqNo sent after the 3rd DUP ACK triggered Fast Retransmit request)==>keeps everything simple robust. These packet copies remained on packet copies queue, if needed could always be requested to be retransmitted by a next 3rd DUP ACK.

Note: earlier implementation's existing already in place 3rd DUP ACK retransmit & RTO Timeout retransmit mechanism can remain as is, unaffected by Corrections (whether or not this RTO Timeout calculation differs from fixed 850 ms). Improvements just needs to ‘spoof next ack’ on 3rd DUP ACK or eg 850 ms timeout (earlier implementation's existing retransmission mechanism unaffected), ‘discard’ enqueue retransmission packets on exiting fast retransmit recovery, & forwarding DUP SEQNo packet (if any) without replacing packet copies.
And now this final layer/improvement modifications will add TCP Friendliness not just 100% bandwidth utilisation capability:

1. Concept: NextGenTCP Intercept Software primarily ‘stroke’ out a new packet only when an ACK returns (or when returning ACK/s cumulatively frees up sufficient bytes in Sliding Window to allow this new packet to be sent), unless MSTCP CWND incremented & injects ‘extra’ new packets (after the very 1st packet drop event ie 3^{rd} DUP ACK fast retransmit request or RTO Timeout, MSTCP increments CWND only linearly ie extra 1*SMSS per RTT if all previous RTT's sent packets are all ACKed) OR Intercept Software algorithm injects more new packets by ‘spoof ack/s’.
2. Intercept Software keeps track of present Total In-Flight-Bytes (ie largest SentSeqNo−largest ReceivedACKNo). All MSTCP packets are first enqueued in a ‘MSTCP transmit buffer’ before being forwarded onwards.
Only upon the very 1st packet drop event eg 3rd DUP ACKs fast retransmit request or RTO Timeout, Intercept Software does not ‘spoof next ack’ to pre-empt MSTCP's from noticing & react to such event==>MSTCP thereafter always' linear increment CWND by 1*SMSS per RTT if all this RTT's packets are all acked==>Intercept Software could now easily ‘step in’ to effect any ‘increment sizes’ via ‘immediate required # of spoof acks’ with successive as yet unacked SeqNos (after this initial 1st drop, Intercept Software continues with its usual 3rd DUP ACK or 850 ms ‘spoof next ack ’).
3. Intercept Software now tracks min(RTT) ie latest best estimate of actual uncongested RTT of the source-destination pair (min(RTT) initialised to very large eg 30,000 ms & set min(RTT)=latest returning RTT if latest returning RTT<min(RTT)), & examine every returning ACK packet's RTT if =<min(RTT)+eg 10 ms variance (window's &/or network's real time variance allowance) THEN forward returning ACK packet to MSTCP & ensures present Total In-Flight-Bytes is incremented by an ‘extra’ packet's worth by immediately ‘spoof next ack’ the 1st enqueued ‘MSTCP transmit packet’s with ACKNo set to the next packet's SeqNo on the ‘maintained’ Packet Copies list or with ACKNo set to SeqNo+data length (or if none enqueued on the ‘MSTCP transmit queue’, then ‘spoof next ack’ the new MSTCP packet received in response to the latest forwarded returning ACK which only shifts Sliding Window's left ledge, note this will not immediately increment CWND if received after the initial Fast Retransmit). ie if returning ACK's RTT is ‘uncongested’ then could increment present Total-In-Flight-Bytes by 1 packet's worth, in addition to the ‘basic’ stroking one out for every one returning ACK==>this is equivalent to Exponential Increase (can further be usefully adapted to eg ‘one tenth’ increment per RTT eg increment inject 1 ‘extra’ packet for every 10 returning ACKs with ‘uncongested’ RTTs)
If returning ACK packet's RTT>min(RTT)+eg 10 ms variance (ie onset of congestions) THEN forward returning ACK packet to MSTCP & ‘do nothing’ since MSTCP would now generate a new packet in response to shift of Sliding Window's left edge & only increment CWND by 1*SMSS if all this RTT's packets are all acked: ie during congestions Intercept Software does not ‘extra’ increment present Total-In-Flight-Bytes on its own (MSTCP will only generate a new packet to take the place of the ACKed packet which has now left the network, maintaining the same present Total-In-Flight-Bytes)==>equivalent to Linear additive 1*SMSS increment per RTT if all this RTT's packets all acked.
4. Whenever after exiting fast retransmit recovery phase or after an RTO Timeout, will want to ensure Total In-Flight-Bytes is proportionally reduced (Note: Total In-Flight-Bytes could be different from MSTCP's CWND size !) to Total In-Flight-Bytes at the instant when the packet drop event occurs*[1,000 ms/(1,000 ms+(latest returning ACK's RTT−min(RTT))]: since 1 second is always the bottleneck link's equivalent bandwidth, & the latest Total In-flight-Bytes' equivalent in milliseconds is 1,000 ms+(latest returning ACK's RTT−min(RTT)). This is accomplished by eg generate & forward a ‘0’ window update packet (& also modifying all incoming network packets' Receiver Window Size field to ‘0’) to MSTCP during the required period of time, &/OR enqueuing a number of MSTCP newly generated packet/s in ‘MSTCP transmit queue’ UNTIL Total In-flight-Bytes=<Total In-Flight-Bytes at the instant when the packet drop event occurs*1,000 ms (1,000 ms+(latest returning ACK's RTT−min(RTT))]
Here is a variant NextGenTCP/NextGenFTP implementation (or direct modifications/code module add-ons to resident RFC's TCPs own source code itself) based on the immediately preceding implementations, with Intercept Software continues to:
1. Concept: NextGenTCP/NextGenFTP Intercept Software primarily ‘stroke’ out a new packet only when an ACK returns (or when returning ACK/s cumulatively frees up sufficient bytes in Sliding Window to allow this new packet to be sent), unless resident RFC's TCP's own CWND incremented & injects ‘extra’ new packets (after the very 1st packet drop event ie 3^{rd} DUP ACK fast retransmit request or RTO Timeout, resident RFC's TCP increments own CWND only linearly ie extra 1*SMSS per RTT if all previous RTT's sent packets are all ACKed) OR Intercept Software algorithm injects more new packets by ‘spoof ack/s’ (to resident RFC's TCP eg with ACKNo=present smallest ‘unacked’ sent SeqNo+this corresponding packet's datalength (or just simply+eg 1*SMSS . . . etc).
2. Intercept Software keeps track of present Total In-Flight-Bytes (ie largest SentSeqNo−largest ReceivedACKNo). Optionally, all resident RFC's TCP packets may or may not be first enqueued in a ‘TCP transmit buffer’ before being forwarded onwards.
Only upon the very 1st packet drop event eg 3rd DUP ACKs fast retransmit request or RTO Timeout, Intercept Software does not ‘spoof next ack’ to pre-empt resident RFC's TCP from noticing & react to such packet drop/s event==>MSTCP thereafter always ‘linear increment CWND by 1*SMSS per RTT if all the RTT's packets are all acked==>Intercept Software could now easily ‘step in’ to effect any ‘increment sizes’ via ‘immediate spoof ack/s’ whenever required eg after resident RFC's TCP fast retransmit & halves its own CWND size . . . &/or RTO Timeout resetting its own CWND size to 1*SMSS (after this initial 1st drop, Intercept Software thereafter ‘always’ continue with its usual 3rd DUP ACK &/or 850 ms ‘spoof next ack’, to always ‘totally’ prevent resident RFC's TCP from further noticing any subsequent packet drop/s event/s whatsoever). On receiving the resident RFC's TCP's retransmission packet/s in response to the only very initial 1^{st} packet drop/s event that it would ever be ‘allowed’ to notice & react to, Intercept Software could simply ‘discard’ them & not forward them onwards at all, since Intercept Software could & would have ‘performed’ all necessary fast retransmissions &/or RTO Timeout retransmissions from the existing maintained Packet Copies list.
2. Intercept Software now tracks min(RTT) ie latest best estimate of actual uncongested RTT of the source-destination pair (min(RTT) initialised to very large eg 30,000 ms & set min(RTT)=latest returning RTT if latest returning RTT<min(RTT)), & examine every returning ACK packet's RTT if =<min(RTT)+eg 10 ms variance (window's &/or network's real time variance allowance) THEN forward returning ACK packet to resident RFC's TCP & ensures present Total In-Flight-Bytes is incremented by an ‘extra’ packet's worth by immediately ‘spoof next ack’ the present 1st smallest sent ‘unacked’ packet's SeqNo looking up the maintained ‘unacked’ sent Packet Copies list) with ACKNo set to the very next packet's SeqNo on the ‘maintained’ Packet Copies list or with ACKNo set to the 1^{st} smallest ‘unacked’ sent Packet Copy's SeqNo+its data length (or if none on the list, then as soon as possible immediately ‘spoof next ack’ any new resident RFC's TCP's packet received in response to the latest forwarded returning ACK which only shifts Sliding Window's left ledge which may or may not have immediately increment CWND if received after the initial Fast Retransmit ie if resident RFC's TCP is currently in ‘linear increment per RTT’ mode). ie if returning ACK's RTT is ‘uncongested’ then could increment present Total-In-Flight-Bytes by 1 packet's worth, in addition to the ‘basic’ stroking one out for every one returning ACK==>this is equivalent to Exponential Increase (can further be usefully adapted to eg ‘one tenth’ increment per RTT eg increment inject 1 ‘extra’ packet for every 10 returning ACKs with ‘uncongested’ RTTs). Intercept Software may optionally further ‘overrule’/prevents whenever required, or useful’ eg if the current returning ACK's RTT>‘uncongested’ RTT or min(RTT)+tolerance variance . . . etc) the total in-flight-bytes from being incremented effects due to resident RFC TCP's own CWND ‘linear increment per RTT’, eg by introducing a TCP transmit queue where any such incremented ‘extra’ undesired TCP packet/s could be enqueued for later forwarding onwards when ‘convenient’, &/or eg by generating ‘0’ receiver window size update packet &/or modifying all incoming packets' RWND field value to ‘0’ during the required period.
Optionally, if returning ACK packet's RTT>min(RTT)+eg 10 ms variance (ie onset of congestions) THEN Intercept Software could just forward returning ACK packet/s to resident RFC's TCP & ‘do nothing’, since MSTCP would now generate a new packet in response to shift of Sliding Window's left edge & only increment CWND by 1*SMSS if all this RTT's packets are all acked: ie during congestions Intercept Software does not ‘extra’ increment present Total-In-Flight-Bytes on its own (resident RFC's TCP will only generate a new packet to take the place of the ACKed packet which has now left the network, maintaining the same present Total-In-Flight-Bytes)==>equivalent to Linear additive 1*SMSS increment per RTT if all this RTT's packets all acked.
3. Whenever after exiting fast retransmit recovery phase or after an RTO Timeout, will want to ensure Total In-Flight-Bytes is subsequently proportionally reduced to, & at the same time subsequently also able to be ‘kept up’ (Note: Total In-Flight-Bytes could be different from resident RFC's TCP's own CWND size !) to be the same as (but not more than) the Total In-Flight-Bytes at the instant when the packet drop event occurs*[1,000 ms 1,000 ms+(latest returning ACK's RTT−min(RTT))]: since 1 second is always the bottleneck link's equivalent bandwidth, & the latest Total In-flight-Bytes' equivalent in milliseconds is 1,000 ms+(latest returning ACK's RTT−min(RTT)). This is accomplished by eg generate & forward a ‘0’ window update packet (& also modifying all incoming network packets' Receiver Window Size field to ‘0’) to resident RFC's TCP during the required period of time, &/or enqueuing a number of resident RFC's TCP's newly generated packet/s in ‘TCP transmit queue’ UNTIL Total In-flight-Bytes=<Total In-Flight-Bytes at the instant when the packet drop event occurs*[1,000 ms/(1,000 ms+(latest returning ACK's RTT−min(RTT))]
4. Intercept Software here simply needs to continuous track the ‘total’ number of outstanding in-flight-bytes (&/or in-flight-packet) at any time (ie largest SentSeqNo−largest ReceivedACKNo, &/or track &record the number of outstanding in-flight-packets eg by looking up the maintained ‘unacked’ sent Packet Copies list structure or eg approximate by tracking running total of all packets sent−running total of all ‘new’ ACKs received (ACK/s with Delay ACKs enabled may at times ‘count’ as 2 ‘new’ ACKs)), & ensures that after completion of packet/s drop/s events handling (ie after exiting fast retransmit recovery phase, &/or after completing RTO Timeout retransmission: note after exiting fast retransmit recovery phase, resident RFC's TCPs will normally halve its CWND value thus will normally reduce/restrict the subsequent total number of outstanding in-flight-bytes possible, & after completing RTO Timeout retransmission resident RFC's TCPs will normally reset CWND to 1*SMSS thus will normally reduce/restrict the total number of outstanding in-flight-bytes possible) subsequently the total number of outstanding in-flight-bytes (or in-flight-packets) could be allowed to be of same number (but not more) as this ‘calculated’ total number of In-Flight-Bytes at the instant when the packet drop event occurs*[1,000 ms/(1,000 ms+(latest returning ACK's RTT−min(RTT))]) (see preceding page's Paragraph 4), OR the total number of outstanding in-flight-packets could be allowed to be of same number (but not more) as this total number of In-Flight-Packets at the instant when the packet drop event occurs*[1,000 ms/(1,000 ms+(latest returning ACK's RTT−min(RTT))]), by immediately ‘Spoofing’ an ACK to resident RFC's TCPs with ACKNo=the present smallest ‘unacked’ sent SeqNo+total number of In-Flight-Bytes at the instant when the packet drop event occurs*[1,000 ms/(1,000 ms+(latest returning ACK's RTT−min(RTT))]
(&/or alternatively successively immediately ‘Spoofing’ ACK to resident RFC's TCP with ACKNo=the present smallest sent ‘unacked’ SeqNo+this corresponding packet's datalength (a packet here would be considered to be ‘acked’ if ‘spoof acked’), UNTIL the present total number of in-flight-bytes (or in-flight-packet) had been ‘restored’ to total number of In-Flight-Bytes (or In-Flight-Packets) at the instant when the packet drop event occurs*[1,000 ms/(1,000 ms+(latest returning ACK's RTT−min(RTT))] (see preceding page's Paragraph 4).
Note this implementation keeps track of the total number of outstanding in-flight-bytes (&/or in-flight-packets) at the instant of packet drop/s event, to calculate the ‘allowed’ total in-flight-bytes subsequent to resident RFC's TCPs exiting fast retransmit recovery phase &/or after completing RTO Timeout retransmission & decrementing the CWND value (after packet drop/s event), & ensure after completion of packet drop/s event handling phase subsequently the total outstanding in-flight-bytes (or in-flight-packets) is ‘adjusted’ to be able to be ‘kept up’ to be the same number as the ‘calculated’ size eg by ‘spoofing an ‘algorithmically derived’ ACKNo’ to shift resident RFC's TCP's own Sliding Window's left edge &/or to allow resident RFC's TCP to be able to increment its own CWND value, or successive ‘spoof next ack/s’ . . . etc.
Note the total in-flight-bytes may further subsequently be incremented by resident RFC's TCP increasing its own CWND size, & also by Intercept Software ‘injecting’ extra packets (eg in response to returning ACK's RTT=<‘uncongested’ RTT or min(RTT)+tolerance variance): Intercept Software may ‘track’ & record the largest observed in-flight-bytes size &/or largest observed in-flight-packets (Max-In-Flight-Bytes, &/or Max-In-Flight-Packets) since subsequent to the latest ‘calculation’ of ‘allowed’ total-in-flight-bytes (‘calculated’ after exiting fast retransmit recovery phase, &/or after RTO Timeout retransmission), and could optionally if desired further ‘always’ ensure the total in-flight-bytes (or total in-flight-packets) is ‘always’ ‘kept up’ to be same as (but not to ‘actively’ cause to be more than) this Max-In-Flight-Bytes (or Max-In-Flight-Packets) size eg via ‘spoofing an ‘algorithmically derived’ ACKNo’, to shift resident RFC's TCP's own Sliding Window's left edge &/or to allow resident RFC's TCP to be able to increment its own CWND value, or successive ‘spoof next ack/s’ . . . etc. Note this ‘tracked’/recorded Max-In-Flight-Bytes (&/or Max-In-Flight-Packets) subsequent to every new calculation of ‘allowed’ total in-flight-bytes (&/or in-flight-packets) may dynamically increments beyond the new ‘calculated allowed size, due to resident RFC's TCP increasing its own CWND size, & also due to Intercept Software's increment algorithm ‘injecting’ extra packets
1. Optionally, during 3^{rd} DUP ACK fast retransmit recovery phase, Intercept Software tracks/records the number of returning multiple DUP ACKs with same ACKNo as the original 3^{rd} DUP ACK triggering the fast retransmit, & could ensure that there is a packet ‘injected’ back into the network correspondingly for every one of these multiple DUP ACK/s (or where there are sufficient cumulative bytes freed by the returning multiple ACK/s). This could be achieved eg:
   Immediately after the initial 3^{rd} DUP ACK triggering the fast retransmit is forwarded onwards to resident RFC's TCP, Intercept Software to then now immediately follow-on generate & forward to resident RFC's TCP an exact total number of multiple DUP ACKs with same ACKNo as the original 3^{rd} DUP ACK triggering the fast retransmit recovery phase. This exact number could eg be the total number of In-Flight-Packets at the instant of the initial 3^{rd} DUP ACK triggering the fast retransmit request/2 . . . OR this exact number could be eg such that it is a largest possible integer number*remote sender's TCP's SMSS=<total in-flight-bytes at the instant of the initial 3^{rd} DUP ACK triggering fast retransmit request being forwarded to resident RFC's TCP/2 (note SMSS is the negotiated sender maximum segment size, which should have been ‘recorded’ by Receiver Side Intercept Software during the 3-way handshake TCP establishment stage) . . . OR various other algorithmically derived number (this ensures resident RFC's TCP's already halved CWND size is now again ‘restored’ immediately to approximately its CWND size prior to fast retransmit halving), such as to enable resident RFC's TCP's own fast retransmit mechanism to be able to now immediately ‘stroke’ out a new retransmission packet for every subsequent returning multiple DUP ACK/s.

NOTE: In all, or some, earlier descriptions, the total number of outstanding in-flight-bytes were sometimes calculated as largest SentSeqNo−largest ReceivedACKNo, but note that in this particular context of total in-flight-bytes calculations largest SentSeqNo here should where appropriate really be referring to the actual largest sent byte's SeqNo (not the latest sent packet's SeqNo field's value ! ie should really be [latest sent packet's SeqNo field's value+this packet's datalength]−largest ReceivedACKNo).

Here is a further simplified implementation outline:

Version Simplification:
TCPAccelerator does not ever need to ‘spoof ack’ to pre-empt MSTCP from noticing 3rd DUP ACK fast retransmit request/RTO Timeout whatsoever, only continues to do all actual retransmissions at the same rate as the returning multiple DUP ACKs:
MSTCP halves its CWND/resets CWND to 1*SMSS and retransmit as usual BUT TCPAccelerator ‘discards’ all MSTCP retransmission packets (ie ‘discards’ all MSTCP packets with SeqNo=<largest recorded SentSeqNo)=
==>TCPAccelerator continues to do all actual retransmission packets at the same rate as the returning multiple DUP ACKs+MSTCP's CWND halved/resets thus TCPAccelerator could now ‘spoof ack/s’ successively (starting from the smallest SeqNo packet in the Packet Copies list, to the largest SeqNo packet) to ensure/UNTIL total in-flight-bytes (thus MSTCP's CWND) at any time is ‘incremented kept up’ to calculated ‘allowed’ size:
   At the beginning immediately after 3rd DUP ACK triggering MSTCP fast retransmit, TCPAccelerator immediately continuously ‘spoof ack’ successively (starting from the smallest SeqNo packet in the Packet Copies list, to the largest SeqNo packet) UNTIL MSTCP's now halved CWND value is ‘restored’ to (largest recorded SentSeqNo+its packet's data length)-largest recorded ReceivedACKNo at the time of the 3rd DUP ACK triggering fast retransmit==>MSTCP could ‘stroke’ out new packet/s for each returning multiple DUP ACK, if there is no other enqueued fast retransmit packet/s (eg when only 1 sent packet was dropped)
Note TCP Accelerator may not want to ‘spoof ack’ if doing so would result in total in-flight-bytes incremented to be >calculated ‘allowed’ in-flight-bytes (note each ‘spoof ack’ packets would cause MSTCP's own CWND to be incremented by 1*SMSS) Also alternatively instead of ‘spoof ack’ successively, TCP Accelerator could just spoof a single ACK packet with ACKNO field value set to eg (largest recorded SentSeqNo+its packet's data length at the time of the 3rd DUP ACK triggering fast retransmit−latest largest recorded ReceivedACKNo at the time of the 3rd DUP ACK triggering fast retransmit)/2, or rounded to the nearest integer multiple of 1*SMSS increment value/s which is eg=<calculated ‘allowed’ in-flight-bytes+latest largest recorded ReceivedACKNo.
   Upon exiting fast retransmit recovery phase, MSTCP sets CWND to SStresh (halved CWND)==>TCPAccelerator now continuously ‘spoof ack’ successively (starting from the smallest SeqNo packet in the Packet Copies list, to the largest SeqNo packet) UNTIL MSTCP's now halved CWND value is ‘restored’ to total in-flights-bytes when 3rd DUP ACK received*1,000 ms/(1,000 ms+(latest returning ACK's RTT when very 1st of the DUP ACKs received−recorded min(RTT))
Note TCP Accelerator may not want to ‘spoof ack’ if doing so would result in total in-flight-bytes incremented to be >calculated ‘allowed’ in-flight-bytes (note each ‘spoof ack’ packets would cause MSTCP's own CWND to be incremented by 1*SMSS). Also alternatively instead of ‘spoof ack’ successively, TCP Accelerator could just spoof a single ACK packet with ACKNO field value set to eg (largest recorded SentSeqNo+its packet's data length at the time of the 3rd DUP ACK triggering fast retransmit−latest largest recorded ReceivedACKNo at the time of the 3rd DUP ACK triggering fast retransmit)/2, or rounded to the nearest integer multiple of 1*SMSS increment value/s which is eg=<calculated ‘allowed’ in-flight-bytes+latest largest recorded ReceivedACKNo.
   Upon receiving MSTCP packet with SeqNo=<largest recorded SentSeqNo, in absence of 3rd DUP ACK triggering MSTCP fast retransmit, TCP Accelerator knows this to be RTO Timeouted retransmission==>TCPAccelerator immediately now continuously ‘spoof ack’ successively (starting from the smallest SeqNo packet in the Packet Copies list, to the largest SeqNo packet) UNTIL MSTCP's resetted CWND value is ‘restored’ to total in-flights-bytes when RTO Timeouted retransmission packet received*1,000 ms/(1,000 ms+(latest returning ACK's RTT prior to when RTO Timeouted retransmission packet ‘received−recorded min(RTT))
Note TCP Accelerator may not want to ‘spoof ack’ if doing so would result in total in-flight-bytes incremented to be >calculated ‘allowed’ in-flight-bytes (note each ‘spoof ack’ packets would cause MSTCP's own CWND to be incremented by 1*SMSS). Also alternatively instead of ‘spoof ack’ successively, TCP Accelerator could just spoof a single ACK packet with ACKNO field value set to eg (largest recorded SentSeqNo+its packet's data length at the time of the 3rd DUP ACK triggering fast retransmit−latest largest recorded ReceivedACKNo at the time of the 3rd DUP ACK triggering fast retransmit)/2, or rounded to the nearest integer multiple of 1*SMSS increment value/s which is eg=<calculated ‘allowed’ in-flight-bytes+latest largest recorded ReceivedACKNo
At all times (except during fast retransmit recovery phase) calculated ‘allowed’ in-flight-bytes size (thus MSTCP's CWND size) could be incremented by 1 if latest returning ACK packet's RTT<min(RTT)+eg 10 ms variance==>exponential CWND increments if ‘uncongested’ RTT, linear increment of 1*SMSS per RTT if ‘congested’ RTT.

Of course, TCPAccelerator should also at all times always ‘update’ calculated ‘allowed’ in-flight-size=Max [present calculated ‘allowed’ size’, (largest recorded SentSeqNo+datalength)−largest recorded ReceivedACKNo], since MSTCP may introduce ‘extra’ in-flight-bytes on its own. TCP Accelerator should also at all times immediately ‘spoof ack’ successively to ensure total-in-flight-bytes at all times is ‘kept up’ to the calculated ‘allowed’ in-flight-bytes.

Note a ‘Receiver Side’ Intercept Software could be implemented, adapting the above preceding ‘Sender Side’ implementations, & based on any of the various earlier described Receiver Side TCP implementations in the Description Body: with Receiver Side Intercept Software now able to adjust sender rates & able to control in-flight-bytes size (via eg ‘0’ window updates & generate ‘extra’ multiple DUP ACKs, withholding delay forwarding ACKs to sender TCP . . . etc).

Receiver Side Intercept Software needs also monitor/‘estimate’ the sender TCP's CWND size &/or monitor/‘estimate’ the total in-flight-bytes size &/or monitor/‘estimate’ the RTTs (or OTTs), using various methods as described earlier in the Description Body, or as follows:

1. ‘Receiver Side’ Intercept Module first needs to dynamically track the TCP's total in-flights-bytes per RTT (&/or alternatively in units of in-flights-packets per RTT), this can be achieved as follows (note in-flight-bytes per RTT is usually synonymous with CWND size):

(a)

see http://www.ieee-infocom.org/2004/Papers/33_{—}5.PDF “passive measurement methodology to infer and keep track of the values of two important variables associated with a TCP connection: the sender's congestion window (cwnd) and the connection round trip time (RTT)”

see http://www.cs.unc.edu/˜jasleen/notes/TCP-char.html “Infer a sender's congestion window (CWND) by observing passive TCP traces collected somewhere in the middle of the network. Estimate RTT (one estimate per window transmission) based on estimate of CWND. Motivation: Knowledge of CWND and RTT”

see http://www.pam2005.org/PDF/34310124.pdf “New Methods for Passive Estimation of TCP Round-Trip Times” where two methods to passively measure and monitor changes in round-trip times (RTTs) throughout the lifetime of a TCP connection are explained: first method associates data segments with the acknowledgments (ACKs) that trigger them by leveraging the bi-directional TCP timestamp echo option, second method infers TCP RTT by observing the repeating patterns of segment clusters where the pattern is caused by TCP self-clocking”

see Google Search term “tcp in flight estimation”

### &/OR

(b)
(i). simultaneous with the normal TCP connection establishment negotiation, Receiver Side Intercept Module negotiates & establishes another ‘RTT marker’ TCP connection to the remote Sender TCP, using ‘unused port numbers’ on both ends, & notes the initial ACKNo (InitMarkerACKNo) & SeqNo (InitMarkerSeqNo) of the established TCP connection (ie before receiving any data payload packet) This attempted ‘RTT maker’ TCP connection could even be to an ‘invalid port’ of at the remote sender (in which case Receiver Side Intercept Software would expect auto-reply from remote sender of ‘invalid port’), or further may even be to the same remote sender's port as the normal TCP connection itself (which Receiver Side Intercept Software should ‘refrain’ from sending any ‘ACK’ back if receiving data payload packet/s from remote sender TCP). Receiver Side Intercept Software notes the negotiated ACKNo (ie the next expected SeqNo from remote sender) & SeqNo (ie the present SeqNo of local receiver) contained in the 3^{rd} ‘ACK’ packet (which was generated & forwarded to remote sender) in the ‘sync-sync ack-ACK’ ‘RTT marker’ TCP connection establishment sequence, as MarkerInitACKNo & MarkerInitSeqNo respectively.
(ii). after the normal TCP connection handshake is established, Receiver Side Intercept Module records the ACKNo & SeqNo of the subsequent 1^{st} data packet received from remote sender's normal TCP connection when the 1^{st} data payload packet next arrives on the normal TCP connection (as InitACKNo & SeqNo). Receiver Side Intercept Module then generates an ‘RTT Marker’ packet with 1 byte ‘garbage’ data with this packet's Sequence Number field set to MarkerInitSeqNo+2 (or +3/+4/+5 . . . +n) to the remote ‘RTT marker’ TCP connection (Optionally, but not necessarily required, with this packet's Acknowledgement field value optionally set to MarkerInitACKNo).
(iii). Receiver Side Intercept Software continuously examine the ACKNo & SeqNo of all subsequent data packet/s received from remote sender's normal TCP connection when the data payload packet/s subsequently arrives on the normal TCP connection, and update records of the largest ACKNo value & SeqNo value observed so far (as MaxACKNo & MaxSeqNo), UNTIL it receives an ACK packet back on the ‘RTT marker’ TCP connection from the remote sender ie in response to the ‘RTT Marker’ packet sent in above paragraph:
   whereupon the total in-flight-bytes during this RTT could be ascertained from MaxACKNo+this latest arrived ACK packet's datalength−InitACKNo (which would usually be synonymous as the remote sender TCP's own CWND value), & whereupon Receiver Side Intercept Software now resets InitACKNo=MaxACKNo+this latest arrived ACK packet's datalength & generates an ‘RTT Marker’ packet with 1 byte ‘garbage’ data with this packet's Sequence Number field set to MarkerInitSeqNo+2 (or +3/+4/+5 . . . +n) to the remote ‘RTT marker’ TCP connection (Optionally, but not necessarily required, with this packet's Acknowledgement field value optionally set to MarkerInitACKNo) ie in similar adapted manner as described in Paragraph 1 of page 197 & page 198 of the Description Body & then again repeat the procedure flow loop at preceding Paragraph (iii) above.

Obviously the ‘RTT Marker’ packet could get ‘dropped’ before reaching remote sender or the remote sender's ACK in response to this ‘out-of-sequence’ received ‘RTT Marker’ packet could get ‘dropped’ on its way from remote sender to local receiver's ‘RTT Marker’ TCP, thus Receiver Side Intercept Software should be alert to such possibilities eg indicated by much lengthened time period than previous estimated RTT without receiving ACK back for the previous sent ‘RTT Marker packet to then again immediately generate an immediate replacement ‘RTT Marker’ packet with 1 byte ‘garbage’ data with this packet's Sequence Number field set to MarkerInitSeqNo+2 (or +3/+4/+5 . . . +n) to the remote ‘RTT marker’ TCP connection . . . etc.

The ‘RTT Marker’ TCP connection could further optionally have Timestamp Echo option enabled in both directions, to further improve RTT &/or OTT, sender TCP's CWND tracking &/or in-flight-bytes tracking . . . Etc.

Above Sender Based Intercept Software/s could easily be adapted to be Receiver Based, using various combinations of earlier described Receiver Based techniques &methods in the Description Body.

Here is one example outline among many possible implementations of a Receiver Based Intercept Software, adapted from above described Sender Based Intercept Software/s:

1. Receiver's resident TCP initiates TCP establishment by sending a ‘SYNC’ packet to remote sender TCP, & generates an ‘ACK’ packet to remote sender upon receiving a ‘SYNC ACK’ reply packet from remote sender. Its preferred but not always mandatory that large window scaled option &/or SACK option &/or Timestamp Echo option &/or NO-DELAY-ACK be negotiated during TCP establishment. The negotiated max sender window size, max receiver window size, max segment size, initial SeqNo & ACKNo used by sender TCP, initial SeqNo & ACKNo used by receiver TCP, and various chosen options are recorded/noted by Receiver Side Intercept Software.
1. Upon receiving the very 1^{st} data packet from remote sender TCP, Receiver Side Intercept Software records/notes this very initial 1^{st} data packet's SeqNo value Sender1stDataSeqNo, ACKNo value Sender1stDataACKNo, the datalength Sender1stDataLength. When receiver's resident TCP generates an ACK to remote sender acknowledging this very 1^{st} data packet, Receiver Side Intercept Software will ‘optionally discard’ this ACK packet if it is a ‘pure ACK’ or will modify this ACK packet's ACKNo field value (if it's a ‘piggyback’ ACK, &/or also even if it's a ‘pure ACK’) to the initial negotiated ACKNo used by receiver TCP (alternatively Receiver Side Intercept Software could modify this ACK packet's ACKNo to be ACKNo −1 if it's a ‘pure ACK’ or will modify this ACK packet's ACKNo (if it's a ‘piggyback’ ACK) to be ACKNo −1 (this very particular very 1^{st} ACK packet's ACK field's modified value of ACKNo −1, will be recorded/noted as Receiver1stACKNo): thus the costs to the sender TCP will be just ‘a single byte’ of potential retransmissions instead of ‘a packet's worth’ of potential retransmissions).
   All subsequent ACK packets generated by receiver's resident TCP to remote sender TCP will be intercepted Receiver Side Intercept Software to modify the ACK packet's ACKNo to be the initial negotiated ACKNo used by receiver TCP (alternatively to be Receiver1stACKNo)→thus it can be seen that after 3 such modified ACK packets (all with ACKNo field value all of initial negotiated ACKNo used by receiver TCP, or alternatively all of Receiver1stACKNo), sender TCP will now enters fast retransmit recover phase & incurs ‘costs’ retransmitting the requested packet or alternatively the requested byte.
   Receiver Side Intercept Software upon detecting this 3^{rd} DUP ACK being forwarded to remote sender will now generate an exact number of ‘pure’ multiple DUP ACKs (all with ACKNo field value all of initial negotiated ACKNo used by receiver TCP, or alternatively all of Receiver1stACKNo) to the remote sender TCP. This exact number could eg be the total number of In-Flight-Packets at the instant of the initial 3^{rd} DUP ACK being forwarded to remote sender TCP/2 . . . OR this exact number could be eg such that it is a largest possible integer number*remote sender's TCP's negotiated SMSS=<total in-flight-bytes at the instant of the initial 3^{rd} DUP ACK being forwarded to remote sender TCP/2 (note SMSS is the negotiated sender maximum segment size, which should have been ‘recorded’ by Receiver Side Intercept Software during the 3-way handshake TCP establishment stage) . . . OR various other algorithmically derived number (this ensures remote sender TCP's halved CWND size upon entering fast retransmit recovery on 3^{rd} DUP ACK is now again ‘restored’ immediately to approximately its CWND size prior to entering fast retransmit halving), such as to enable remote sender TCP's own fast retransmit recovery phase mechanism to be able to now immediately ‘stroke’ out a ‘brand new’ generated packet/s &/or retransmission packet/s for every subsequent returning multiple DUP ACK/s (or where sufficient cumulative ‘bytes’ freed by the multiple DUP ACK/s).
   Similar Receiver Side Intercept Software upon detecting/receiving retransmission packet (ie with SeqNo<latest largest recorded received packet's SeqNo from remote sender) from remote sender TCP, while remote sender TCP is not in fast retransmit recovery phase (ie this will correspond to the scenario of remote sender TCP RTO Timedout retransmit), will similarly now generate an exact number of ‘pure’ multiple DUP ACKs (all with ACKNo field value all of initial negotiated ACKNo used by receiver TCP, or alternatively all of Receiver1stACKNo) to the remote sender TCP. This exact number could eg be the total number of In-Flight-Packets at the instant of the retransmission packet being received from remote sender TCP−remote TCP's CWND reset value in packet/s (usually 1 packet, ie 1*SMSS bytes)*eg 1,000 ms/(1,000 ms+(RTT of the latest received RTO Timedout retransmission packet from remote sender TCP−latest recorded min(RTT)) . . . OR this exact number could be eg such that it is a largest possible integer number*remote sender's TCP's negotiated SMSS=<total in-flight-bytes at the instant of the retransmission packet being received from remote sender TCP*eg 1,000 ms/(1,000 ms+(RTT of the latest received packet from remote sender TCP which ‘caused’ this ‘new’ ACK from receiver TCP−latest recorded min(RTT)) (note SMSS is the negotiated sender maximum segment size, which should have been ‘recorded’ by Receiver Side Intercept Software during the 3-way handshake TCP establishment stage) . . . OR various other algorithmically derived number (this ensures remote sender TCP's reset CWND size upon RTO Timedout retransmit is now again ‘restored’ immediately to a calculated ‘allowed’ value), such as to enable remote sender TCP's own subsequent fast retransmit recovery phase mechanism to continue to be able to ensure subsequent total in-flight-bytes could be ‘kept up’ to the calculated ‘allowed’ value while removing bufferings in the nodes along the path, & thereafter once the bufferings in the nodes along the path have been eliminated to now enable receiver TCP to immediately ‘stroke’ out a ‘brand new’ generated packet/s &/or retransmission packet/s for every subsequent returning multiple DUP ACK/s (or where sufficient cumulative ‘bytes’ freed by the multiple DUP ACK/s). Optionally, Receiver Side Intercept Software may want to subsequently now use this received RTO Timedout retransmitted packet's SeqNo+its datalength as the new incremented ‘clamped’ ACKNo.
   After the 3^{rd} DUP ACK has been forwarded to remote sender TCP to trigger fast retransmit recovery phase, subsequently Receiver Side Intercept Software upon generating/detecting a ‘new’ ACK packet (ie not a ‘partial’ ACK) forwarded to remote sender TCP (which when received at remote sender TCP would cause remote sender TCP to exit fast retransmit recovery phase), will now immediately generate an exact number of ‘pure’ multiple DUP ACKs (all with ACKNo field value all of initial negotiated ACKNo used by receiver TCP, or alternatively all of Receiver1stACKNo) to the remote sender TCP. This exact number could eg be the [{total in Flight packets (or trackedCWND in bytes/sender SMSS in bytes)/(1+curRTT in seconds eg RTT of the latest received packet from remote sender TCP which ‘caused’ this ‘new’ ACK from receiver resident TCP−latest recorded minRTT in seconds)}−total in Flight packets (or trackedCWND in bytes/sender SMSS in bytes)/2]
      ie target in Flights or CWND in packets to be ‘restored’ to—remote sender TCP's halved CWND size on exiting fast retransmit (or various similar derived formulations) (note SMSS is the negotiated sender maximum segment size, which should have been ‘recorded’ by Receiver Side Intercept Software during the 3-way handshake TCP establishment stage) . . . OR various other algorithmically derived number (this ensures remote sender TCP's CWND size which is set to Sstresh value (ie halved original CWND value) upon exiting fast retransmit recovery on receiving ‘new’ ACK is now again ‘restored’ immediately to a calculated ‘allowed’ value), such as to enable remote sender TCP's own subsequent fast retransmit recovery phase mechanism to continue to be able to ensure subsequent total in-flight-bytes could be ‘kept up’ to the calculated ‘allowed’ value while removing bufferings in the nodes along the path, & thereafter once the bufferings in the nodes along the path have been eliminated to now enable receiver TCP to immediately ‘stroke’ out a ‘brand new’ generated packet/s &/or retransmission packet/s for every subsequent returning multiple DUP ACK/s (or where sufficient cumulative ‘bytes’ freed by the multiple DUP ACK/s).
      Thereafter each forwarded modified ACK packet to the remote sender, will increment remote sender TCP's own CWND value by 1*SMSS, enabling ‘brand new’ generated packet/s &/or retransmission packet/s to be ‘stroked’ out correspondingly for every subsequent returning multiple DUP ACK/s (or where sufficient cumulative ‘bytes’ freed by the multiple DUP ACK/s)→ACKs Clocking is preserved, while remote sender TCP continuously stays in fast retransmit recovery phase. With sufficiently large negotiated window sizes, whole Gigabyte worth of data transfer could be completed staying in this fast retransmit recovery phase (Receiver Side Intercept Software here ‘clamps’ all ACK packets' ACKNo field value to all be of initial negotiated ACKNo used by receiver TCP, or alternatively all be of Receiver1stACKNo)
      Further, instead of just forwarding each receiver TCP generated ACK packet/s modifying their ACKNo field value to all be the same ‘clamped’ value, Receiver TCP should only forward 1 single packet only when the cumulative ‘bytes’ (including residual carried forward since the previous forwarded 1 single packet) freed by the number of ACK packet/s is equal to or exceed the recorded negotiated remote sender TCP's max segment size SMSS. Note each multiple DUP ACK received by remote sender TCP will cause an increment of 1*SMSS to remote sender TCP's own CWND value. This 1 single packet should contain/concatenate all the data payload/s of the corresponding cumulative packet/s' data payload, incidentally also necessitating ‘checksums’ . . . etc to be recomputed & the 1 single packet to be re-constituted usually based on the latest largest SeqNo packet's various appropriate TCP field values (eg flags, SeqNo, Timestamp Echo values, options . . . etc).
      Upon detecting that the cumulative number of ‘bytes’ remote sender TCP's CWND has been progressively incremented (each multiple DUP ACKs increments remote sender TCP's CWND by 1*SMSS) getting close to (or getting close to eg half . . . etc) the remote sender TCP's negotiated max window size, &/or getting close to Min [negotiated remote sender TCP's max window size (ie present largest received packet's SeqNo from remote sender+its data length−the last ‘clamped’ ACKNo field value used to modify all receiver TCP generated ACK packets' ACKNo field value, now getting close to (or getting close to eg half . . . etc) of the remote sender TCP's negotiated max window size), negotiated receiver TCP's max window size] Receiver Based Intercept Software will thereafter always use this present largest received packet's SeqNo from remote sender, or alternatively will thereafter always use this present largest received packet's SeqNo from remote sender+its datalength −1, as the new ‘clamped’ clamped’ ACKNo field value to be used to modify all receiver TCP/Intercept Software generated ACK packets' ACKNo field value . . . & so forth . . . repeatedly→upon receiving this initial first new ‘clamped’ ACKNo DUP ACKs remote sender TCP will exit present fast retransmit recovery phase setting its CWND value to Sstresh (ie halved CWND) thus Receiver Based Intercept Software will hereby immediately generate an ‘exact’ number of multiple DUP ACKs to ‘restore’ remote sender TCP's CWND value to be ‘unhalved’, & subsequently upon remote sender TCP receiving the ‘follow-on’ new ‘clamped’ ACKNo 3 DUP ACKs it will again immediately enter into another new fast retransmit recovery phase . . . & so forth . . . repeatedly.
      Similarly, upon Receiver Side Intercept Software detecting that 3 new packets with out-of-order SeqNo have been received from remote sender (ie there is a ‘missing’ earlier SeqNo) Receiver Based Intercept Software will thereafter always use this present ‘missing’ SeqNo (BUT not to use this present largest received packet's SeqNo from remote sender+its datalength), as the new ‘clamped’ clamped’ ACKNo field value to be used subsequently to modify all receiver TCP/Intercept Software generated ACK packets' ACKNo field value . . . & so forth . . . repeatedly. Note Receiver Based Intercept Software will thereafter always use only this present ‘missing’ SeqNo as the new ‘clamped’ clamped’ ACKNo field value to be used subsequently to modify all receiver TCP/Intercept Software generated ACK packets' ACKNo field value, since Receiver Based Intercept Software here now wants the remote sender TCP to retransmit the corresponding whole complete packet indicated by this starting ‘missing’ SeqNo.
      Note that DUP ACK/s generated by Receiver Side Intercept Software to remote sender TCP may be either ‘pure’ DUP ACK without data payload, or ‘piggyback’ DUP ACK ie modifying outgoing packet/s' ACKNo field value to present ‘clamped’ ACKNo value & recomputed checksum value.
      Also while Receiver Side Intercept Software ‘clamped’ the ACKNo/s sent to remote sender TCP to ensure remote sender TCP is almost ‘continuously in fast retransmit recovery phase, Receiver Side Intercept Software should also ensure that remote sender TCP does not RTO Timedout because some received segment/s’ with SeqNo >=‘clamped’ ACKNo would not be ACKed to the remote sender TCP:
      Thus Receiver Side Intercept software should always ensure a new incremented ‘clamped’ ACKNo is utilised such that remote sender TCP does not unnecessarily RTO Timedout retransmit, eg by maintaining a list structure recording entries of all received segment SeqNo/datalength/local systime when received. Receiver Side Intercept Software would eg utilise a new incremented ‘clamped’ ACKNo, which is to be equal to the largest recorded segment's SeqNo on the list structure+this segment's datalength, & which not incidentally cause any ‘missing’ segment/s' SeqNo to be erroneously included/erroneously ACKed (this ‘missing’ segment/s' SeqNo is detectable on the list structure), whenever eg an entry's local systime when the segment is received+eg the latest ‘estimated’ RTT/2 (ie approx the one-way-trip time from local receiver to remote sender) becomes >=eg 700 ms (ie long before RFC TCPs' minimum RTO Timeout ‘floor’ value of 1,000 ms) . . . or according to various derived algorithm/s etc. All entries on the maintained received segments SeqNo/datalength/local systime when received list structure with SeqNo<this ‘new’ incremented’ ACKNo could now be removed from the list structure.
      It is preferred that the TCP connection initially negotiated SACK option, so that remote TCP would not ‘unnecessarily’ RTO Timedout retransmit (even if the above ‘new’ incremented ACKNo scheme to pre-empt remote sender TCP from RTO Timedout retransmit scheme is not implemented): Receiver Side Intercept Software could ‘clamp’ to same old ‘unincremented’ ACKNo & not modify any of the outgoing packets' SACK fields/blocks whatsoever . . . .
2. Various of the earlier described RTT/OTT estimation techniques, &/or CWND estimation techniques (including Timestamp Echo option, parallel ‘Marker TCP’ connection establishment, inter-packet-arrivals, synchronisation packets . . . etc) could be utilised to detect/infer ‘uncongested’ RTT/OTT. Eg if parallel ‘Marker TCP’ connection technique is utilised ie eg periodically sending ‘marker’ garbage 1 byte packet with out-of-order successively incremented SeqNo to ‘elicit’ DUP ACKs back from remote sender TCP thus obtained ‘parallel’ RTT estimation→Receiver Based Intercept Software could now exert congestion controls eg increments calculated ‘allowed’ in-flight-bytes by eg 1*SMSS, and thus correspondingly inject ‘extra’ 1 single multiple ‘pure’ DUP ACK packet whenever 1 single ‘normal’ multiple ACK packet is generated (or whenever a number of ‘normal’ multiple ACK/s cumulatively ACKed 1*SMSS bytes ie corresponding to the received segment/s' total datalength/s on the maintained list structure of received segments/datalength/local systime when received) & forwarded to remote sender (as in Paragraph 2 above, or inject 1 single ‘extra’ multiple pure DUP ACK packet for every N ‘normal’ ACK packets/M*cumulative SMSS bytes forwarded to remote sender TCP . . . etc) & the RTTs/OTTs of all the packet/s (or eg the RTT/OTT of the ‘Marker TCP’ during this time period . . . etc) causing the generation of the 1 single ‘normal ACK are all ‘uncongested’ ie eg each of the RTTs=<min(RTT)+eg 10 ms variance.
   Of course, remote sender TCP may also on its own increments total in-flight-bytes (eg exponential increments prior to very initial 1^{st} packet loss event, thereafter linear increment of 1*SMSS per RTT if all sent packets within the RTT all ACKed), thus Receiver Side Intercept Software will always update calculated ‘allowed’ in-flight-bytes=Max[latest largest recorded ReceivedSeqNo+its datalength−latest new ‘clamped’ ACKNo], and could inject a number of extra’ DUP ACK packet/s during any ‘estimated’ RTT period to ensure the total in-flight-bytes is ‘kept up’ to the calculated ‘allowed’ in-flight-bytes.
   If Timestamp Echo option is also enabled in the ‘Marker TCP’ connection this would further enabled OTT from the remote sender to receiver TCP, also OTT from receiver TCP to remote sender TCP, to be obtained & also knowledge of whether any ‘Marker’ packet/s sent are lost. If SACK option is enabled in the ‘Marker TCP’ connection (without above Timestamp Echo option) this would enabled Receiver Based Intercept Software to have knowledge of whether any ‘Marker’ packet/s sent are lost, since the largest SACKed SeqNo indicated in the returning ‘Marker’ ACK packet's SACK Blocks will always indicate the latest largest received ‘Marker’ SeqNo from Receiver Based Intercept Software. Note however since there could only be up to 4 contiguous SACK blocks, may want to immediately use the indicated ‘missing’ gap ACKNo as the next scheduled ‘Marker’ packet's SeqNo whenever such ‘missing’ gap SACKNo is noticed, & continue using this first noticed indicated ‘missing’ gap ACKNo repeatedly alternately in next scheduled ‘Marker’ packet's SeqNo field (instead of, or alternately with the usual successively incremented larger SeqNo), UNTIL this ‘missing’ gap ACKNo is finally ACKed/SACKed in a returning packet from remote sender TCP.

The parallel ‘Marker TCP’ connection could be established to the very same remote sender TCP IP address & port from same receiver TCP address but different port, or even to an invalid port at remote sender TCP.

Note the calculated ‘allowed’ in-flight-bytes (ie based on 1,000 ms 1,000 ms+(RTT of the latest received packet from remote sender TCP which ‘caused’ this ‘new’ ACK from receiver TCP−latest recorded min(RTT))) could be adjusted in many ways eg*fraction multiplier (such as 0.9, 1.1 . . . etc), eg subtracted or added by some values algorithmically derived . . . etc. This calculated ‘allowed’ in-flight-bytes could be used in any of the described methods/sub-component methods in the Description Body as the Congestion Avoidance CWND's ‘multiplicative decrement’ algorithm on packet drop/s events (instead of existing RFC's CWND halving). Further this calculated ‘allowed’ in-flight-size/or CWND value could simply be fixed to be eg ⅔ (which would correspond to assuming fixed 500 ms buffer delays upon packet drop/s events), or simply be fixed to eg 1,000 ms/(1,000 ms+eg 300 ms) ie would here correspond to assuming fixed eg 300 ms buffer delays upon packet drop/s events.

Similarly many different adaptations could be implemented utilising earlier described ‘continuous receiver window size increments’ techniques . . . , &/or utilising Divisional ACKs techniques &/or utilising ‘synchronising’ packets techniques, ‘inter-packets-arrival’ techniques, &/or large ‘scaled’ window size techniques, &/or Receiver Based ACKs Pacing techniques . . . etc, or various combinations/subsets therein. Direct modification of resident TCP source code would obviously renders the implementation much easier, instead of implementing as Intercept Software.

Were all, or a majority, of all TCPs within a geographical subset all implement simple modified TCP Congestion Avoidance algorithm (eg to increment calculated/updated ‘allowed’ in-flight-bytes & thus modified TCP to then increment inject ‘extra’ packet/bytes when latest RTT or OTT=<min(RTT)+variance, &/or to ‘do nothing additional’ when RTT or OTT>min(RTT)+variance, &/or to further decrement the calculated/updated calculated ‘allowed’ in-flight-bytes thus modified TCP to then subsequently ensure total in-flight-bytes does not exceed the calculated/updated ‘allowed’ in-flight-bytes . . . etc), then all TCPs within the geographical subset, including those unmodified RFC TCPs, could all experience better performances.

Further, all the modified TCP could all ‘refrain’ from any increment of calculated/updated allowed total in-flight-bytes when latest RTT or OTT value is between min(RTT)+variance and min(RTT)+variance+eg 50 ms ‘refrained buffer delay (or algorithmically derived period), then close to PSTN real time guaranteed service transmission quality could be experience by all TCP flows within the geographical subset/network (even for those unmodified RFC TCPs). Modified TCPs could optionally be allowed to no longer ‘refrain’ from incrementing calculated ‘allowed’ total in-flight-bytes if eg latest RTT becomes >eg min(RTT)+variance and min(RTT)+variance+eg 50 ms ‘refrained buffer delay (or algorithmically derived period), since this likely signify that there are sizeable proportion of existing unmodified RFC TCP flows within the geographical subset.

Any combination of the methods/any combination of various sub-component/s of the methods (also any combination of various other existing state of art methods)/any combination of method ‘steps’ or sub-component steps, described in the Description Body, may be combined/interchanged/adapted/modified/replaced/added/improved upon to give many different implementations.

Those skilled in the arts could make various modifications & changes, but will fall within the scope of the principles

1. Methods for improving TCP &/or TCP like protocols &/or other protocols, which could be capable of completely implemented directly via TCP/Protocol stack software modifications without requiring any other changes/re-configurations of any other network components whatsoever and which could enable immediate ready guaranteed service PSTN transmissions quality capable networks and without a single packet ever gets congestion dropped, said methods avoid &/or prevent &/or recover from network congestions via complete or partial ‘pause’/‘halt’ in sender's data transmissions, OR algorithmic derived dynamic reduction of CWND or Allowed in Flights values to clear all traversed nodes' buffered packets (or to clear certain levels of traversed nodes' buffered packets), when congestion events are detected such as congestion packet drops &/or returning ACK's round trip time RTT/one way trip time OTT comes close to or exceeded certain threshold value eg known value of the flow path's uncongested RTT/OTT or their latest available best estimate min(RTT)/min(OTT).

2. Methods for improving TCP &/or TCP like protocols &/or other protocols, which could be capable of completely implemented directly via TCP/Protocol stack software modifications without requiring any other changes/re-configurations of any other network components whatsoever and which could enable immediate ready guaranteed service PSTN transmissions quality capable networks and without a single packet ever gets congestion dropped, said methods comprises any combinations/subsets of (a) to (c):
(a) makes good use of new realization/technique that TCP's Sliding Window mechanism's ‘Effective Window’ &/or Congestion Window CWND needs not be reduced in size to avoid &/or prevent &/or recover from congestions.
(b) Congestions instead are avoided &/or prevented &/or recovered from via complete or partial ‘pause’/‘halt’ in sender's data transmissions, OR various algorithmic derived dynamic reduction of CWND or Allowed in Flights values to exact completely clear all (or certain specified level) traversed nodes' buffered packets before resuming packets transmission, when congestion events are detected such as congestion packet drops &/or returning ACK's round trip time RTT/one way trip time OTT comes close to or exceeded certain threshold value eg known value of the flow path's uncongested RTT/OTT or their latest available best estimate min(RTT)/min(OTT).
(c) Instead or in place or in combination with (b) above, TCP's Sliding Window mechanism's ‘Effective Window’ &/or Congestion Window CWND &/or Allowed in Flights value is reduced to a value algorithmically derived dependent at least in part on latest returned round trip time RTT/one way trip time OTT value when congestion is detected, and/or the particular flow path's known uncongested round trip time RTT/one way trip time OTT or their latest available best estimate min(RTT)/min(OTT), and/or the particular flow path's latest observed longest round trip time max(RTT)/one way trip time max(OTT)

3. Methods for virtually congestion free guaranteed service capable data communications network/Internet/Internet subsets/Proprietary Internet segment/WAN/LAN [hereinafter refers to as network] with any combinations/subsets of features (a) to (f):
(a) where all packets/data units sent from a source within the network arriving at a destination within the network all arrive without a single packet being dropped due to network congestions.
(b) applies only to all packets/data units requiring guaranteed service capability.
(c) where the packet/data unit traffics are intercepted and processed before being forwarded onwards.
(d) where the sending source/sources traffics are intercepted processed and forwarded onwards, and/or the packet/data unit traffics are only intercepted processed and forwarded onwards at the originating sending source/sources.
(e) where the existing TCP/IP stack at sending source and/or receiving destination is/are modified to achieve the same end-to-end performance results between any source-destination nodes pair within the network, without requiring use of existing QoS/MPLS techniques nor requiring any of the switches/routers softwares within the network to be modified or contribute to achieving the end-to-end performance results nor requiring provision of unlimited bandwidths at each and every inter-node links within the network.
(f) in which traffics in said network comprises mostly of TCP traffics, and other traffics types such as UDP/ICMP . . . etc do not exceed, or the applications generating other traffics types are arranged not to exceed, the whole available bandwidth of any of the inter-node link/s within the network at any time, where if other traffics types such as UDP/ICMP . . . do exceed the whole available bandwidth of any of the inter-node link/s within the network at any time only the source-destination nodes pair traffics traversing the thus affected inter-node link/s within the network would not necessarily be virtually congestion free guaranteed service capable during this time and/or all packets/data units sent from a source within the network arriving at a destination within the network would not necessarily all arrive ie packet/s do gets dropped due to network congestions.

4. Methods in accordance with any of claims 1-3 above, in said methods the improvements/modifications of protocols is effected at the sender TCP.

5. Methods in accordance with any of claims 1-3 above, in said methods the improvements/modifications of protocols is effected at the receiver side TCP.

6. Methods in accordance with any of claims 1-3 above, in said methods the improvements/modifications of protocols is effected in the network's switches/routers nodes.

7. Methods where the improvements/modifications of protocols is effected in any combinations of locations as specified in any of the claims 4-6 above.

8. Methods where the improvements/modifications of protocols is effected in any combinations of locations as specified in any of the claims 4-6 above, in said methods the existing ‘Random Early Detect’ RED &/or ‘Explicit Congestion Notification’ ECN are modified/adapted to give effect to that disclosed in any of the claims 1-7 above.

9. Methods in accordance with any of the claims 1-8 above or independently where the switches/routers in the network are adjusted in their configurations or setups or operations, such as eg buffer size adjustments, to give effect to that disclosed in any of the claims 1-8 above.

10. Methods for improving TCP &/or TCP like protocols &/or other protocols, which could be capable of completely implemented directly via TCP/Protocol stack software modifications without requiring any other changes/re-configurations of any other network components whatsoever and which could enable immediate ready guaranteed service PSTN transmissions quality capable networks and without a single packet ever gets congestion dropped, said methods avoid &/or prevent &/or recover from network congestions via complete or partial ‘pause’/‘halt’ in sender's data transmissions, OR algorithmic derived dynamic reduction of CWND or Allowed in Flights values to clear all traversed nodes' buffered packets (or to clear certain levels of traversed nodes' buffered packets), when congestion events are detected such as congestion packet drops &/or returning ACK's round trip time RTT/one way trip time OTT comes close to or exceeded certain threshold value eg known value of the flow path's uncongested RTT/OTT or their latest available best estimate min(RTT)/min(OTT), &/OR in accordance with any of claims 2-9 above WHERE IN SAID METHODS:
existing protocols RFCs are modified such that sender's CWND value is instead now never reduced/decremented whatsoever, except to temporarily effect ‘pause’/‘halt’ of sender's data transmissions upon congestions detected (eg by temporarily setting sender's CWND=1*MSS during ‘pause’/‘halt’ & after ‘pause’/‘halt’ completed to then restore sender's CWND value to eg existing CWND value prior to ‘pause’/halt or to some algorithmically derived value, OR eg by equivalently setting sender's CWND=CWND/(1+curRTT in sec−minRTT in sec) OR various similar derived different formulations thereof): the ‘pause’/halt’ interval could be set to eg arbitrary 300 ms or algorithmically derived such as Minimum (latest RTT of returning ACK packet triggering the 3^{rd} DUP ACK fast retransmit OR latest RTT of returning ACK packet when RTO Timedout, 300 ms) or algorithmically derived such as Minimum (latest RTT of returning ACK packet triggering the 3^{rd} DUP ACK fast retransmit OR latest RTT of returning ACK packet when RTO Timedout, 300 ms, max(RTT))
AND/OR
CWND &/or Allowed in Flights value is now ONLY incremented incremented by number of bytes ACKed (ie exponential increment) IF curRTT's RTT or OTT (latest returning ACK's RTT or OTT, in milliseconds)<minRTT or minOTT+tolerance variance eg 25 ms, ELSE incremented by number of bytes ACKed/CWND or Allowed in Flights value (ie linear increment per RTT) or optionally not incremented at all, OR various similar derived different formulations thereof: the exponential &/or linear increment unit size could be varied eg to be 1/10^{th} or ⅕^{th} or ±2 . . . or algorithmic dynamic derived

11. Methods as in accordance with any of the claims 2 or 3 or 10 above, in said Methods:
An Intercept Module, sitting between resident original TCP & the network intercepts examine all incoming & outgoing packets, takes over all 3^{rd} DUPACK fast retransmit & all RTO Timeout retransmission functions from resident original TCP, by maintaining Packet Copies list of all sent but as yet unacked packets/segments/bytes together with their SentTime: thus resident original TCP will now not ever notice any 3^{rd} DUPACK or RTO Timeout packet drop events, and resident original TCP source code is not modified whatsoever
Intercept Module dynamically tracks resident TCP's CWND size (usually equates to in Flight size, if so can very readily be derived from largest SentSeqNo+its data payload size−largest ReceivedAckNo), during any RTT eg using ‘Marker packets’ &/or various pre-existing passive CWND tracking methods, update & record largest attained trackedCWND size.
On 3^{rd} DUPACK triggering fast retransmit, update & record MultAcks (total number of Multiple DUPACKs received during this fast retransmit phase, before exiting this particular fast retransmit phase)
trackedCWND now never ever gets decremented, EXCEPT when/upon exiting fast retransmit phase or when/upon completed RTO Timeout: here trackedCWND could then be decremented eg by the actual total # of bytes retransmitted onwards during this fast retransmit phase (or by the actual # of bytes retransmitted onwards during RTO Timeout)
During fast retransmit phase (triggered by 3^{rd} DUPACK), Intercept Module strokes out 1 packet (can be retransmission packet or normal new higher SeqNo data packet, with priority to retransmission packet/s if any) correspondingly for each arriving subsequent multiple DUPACKs (after the 3^{rd} DUPACK which triggered the fast retransmit phase)

12. Methods as in accordance with any of the claims 10 or 11 above, in said Methods:
the resident TCP source code is modified directly correspondingly thus not needing Intercept Module, and with many attending simplifications achieved

13. Methods as in accordance with the claims 2 or 3 or 10 above, in said Methods:
An Intercept Module, sitting between resident original TCP & the network intercepts examine all incoming & outgoing packets, but does not takes over/interferes with all existing 3^{rd} DUPACK fast retransmit & all RTO Timeout retransmission functions of resident original TCP, & does not needs to maintain Packet Copies list of all sent but as yet unacked packets/segments/bytes together with their SentTime: thus resident original TCP will now continue to notice 3^{rd} DUPACK or RTO Timeout packet drop events, and resident original TCP source code is not modified whatsoever
Intercept Module dynamically tracks resident TCP's CWND size (usually equates to in Flight size, if so can very readily be derived from largest SentSeqNo+its data payload size−largest ReceivedAckNo), during any RTT eg using ‘Marker packets’ &/or various pre-existing passive CWND tracking methods, update & record largest attained trackedCWND size.
On 3^{rd} DUPACK triggering fast retransmit, Intercept Module follows with generation of a number of multiple same ACKNo DUPACKs towards resident TCP such that this number*remote TCP's MSS (max segment size) is =<0.5*trackedCWND (or total in Flights) at the instant of the 3^{rd} DUPACK: resident TCP's CWND value is thus preserved unaffected by existing RFC halving of CWND value on entering fast retransmit phase.
On exiting fast retransmit phase, Intercept Module generates required number of ACK Divisions towards resident TCP to inflate resident TCP's CWND value back to the original CWND value at the instant just before entering into fast retransmit phase: this undo halving of resident TCP's CWND value by existing RFC on exiting fast retransmit phase.
On RTO Timeout retransmission completion, Intercept Module generates required number of ACK Divisions towards resident TCP to restore undo existing RFC reset of resident TCP's CWND value.

14. Methods as in accordance with claim 13 above, in said Methods:
the resident TCP source code is modified directly correspondingly thus not needing Intercept Module, and with many attending simplifications achieved

15. Methods as in accordance with any of claims 2 or 3 or 10-14 above, in said Methods:
resident TCP's CWND value is to be reduced to be CWND (or actual in Flights)*factor of (curRTT−minRTT)/curRTT, OR is to be reduced to be CWND (or actual in Flights)/(1+curRTT in seconds−minRTT in seconds), OR various similarly derived formulations: this resident TCP's CWND reduction now totally replaces earlier needs for ‘temporal pause’ method step.

16. Methods as in accordance with any of claims 2 or 3 or 10-15 above, in said Methods:
resident TCP is directly modified or modification is only in the Intercept Module or both together ensures 1 packet is forwarded onwards to network for each arriving new ACKs (or for each subsequent arriving multiple DUPACKs during fast retransmit phase), OR ensures corresponding cumulative number of bytes is allowed forwarded onwards to network for each arriving new ACKs' cumulative number of bytes freed (or ensures 1 packet is forwarded onwards to network for each subsequent arriving multiple DUPACKs during fast retransmit phase): this is ACKs Clocking maintaining same number of in Flight packets in the network, UNLESS CWND or trackedCWND or Allowed in Flights value incremented which injects more ‘extra’ packets into network
CWND or trackedCWND or Allowed in Flights value is incremented as follows, or various similarly derived formulations (different from existing RFC Congestion Avoidance algorithm):
IF curRTT<minRTT+tolerance variance eg 25 ms
THEN incremented by bytes acked (ie exponential increment)
ELSE incremented by bytes acked/CWND or trackedCWND or Allowed in Flights (ie linear increment per RTT) OR OPTIONALLY do not increment at all.
OPTIONALLY sets CWND or trackedCWND or Allowed in Flights to largest recorded CWND or trackedCWND or Allowed in Flights attained during/under uncongested path conditions (ie curRTT<minRTT+tolerance variance eg 25 ms), when/upon exiting fast retransmit phase or upon completing RTO Timeout retransmissions

17. Methods as in accordance with any of claims 2 or 3 or 10-16 above, in said Methods:
An Intercept Module, sitting between resident original TCP & the network intercepts examine all incoming & outgoing packets, takes over all 3^{rd} DUPACK fast retransmit & all RTO Timeout retransmission functions from resident original TCP, by maintaining Packet Copies list of all sent but as yet unacked packets/segments/bytes together with their SentTime: thus resident original TCP will now not ever notice any 3^{rd} DUPACK or RTO Timeout packet drop events, and resident original TCP source code is not modified whatsoever
Intercept Module dynamically tracks resident TCP's CWND size (usually equates to in Flight size, if so can very readily be derived from largest SentSeqNo+its data payload size−largest ReceivedAckNo), during any RTT eg using ‘Marker packets’ &/or various pre-existing passive CWND tracking methods, update & record largest attained trackedCWND size.
Intercept Module immediately ‘spoof acks’ towards resident TCP whenever receiving new higher SeqNo packets from resident TCP (ie with SpoofACKNo=this packet's SeqNo+its data payload length), thus resident TCP now never ever notice any 3^{rd} DUPACK nor any RTO Timeout packet drop events whatsoever.
Resident MSTCP here now continuous exponential increment its CWND value until CWND reaches MAX[sender max negotiated window size, receiver max negotiated window size] as in existing RFC algorithm, and stays there continuously.
Intercept Module puts all newly received packets from resident TCP, and all RTO & fast retransmission packets generated by Intercept Module into a Transmit Queue (just before the network interface) arranging them all in well ordered ascending SeqNos (lowest SeqNo at front): whenever actual in Flights becomes <Intercept Module's own trackedCWND or Allowed in Flights eg upon Intercept Module's own trackedCWND or Allowed in Flights incremented when ACKs returned, Intercept Module's own trackedCWND or Allowed in Flights needs not be limited in size.
Intercept Module controls MSTCP packets generations rates (start & stop etc) at all times, via changing receiver advertised rwnd value of incoming packets towards resident TCP (eg ‘0’ or very small rwnd value would halt resident TCP's packet generation) and ‘spoof acks’ (which would cause resident TCP's Sliding Window's left edge to advance, allowing new packets to be generated: IF Intercept Module needs to forward onwards packet/s to the network (eg when actual in Flights+this to be forwarded packet's data payload length <trackedCWND or Allowed in Flights) it will first do so front of Transmit Queue if no empty OTHERWISE it will ‘spoof required number of ack/s ’ with successive SpoofACKNo=next as yet unacked Packet Copies list's SeqNo (if Packet Copies list ever becomes empty (ie all Packet Copies have all now becomes ACKed & thus all removed) then resident TCP's Sliding Window size will have become ‘0’ & thus generate new higher SeqNo packet/s filling Transmit Queue ready to be forwarded onwards to network, AND IF Intercept Module needs to ‘pause’ forwarding it can eg reduce trackedCWND (or Allowed in Flights) to be trackedCWND (or Allowed in Flights)/(1+curRTT in seconds−minRTT in seconds) &/or change/generate receiver advertise RWND field to be ‘0’ for a corresponding period &/or SIMPLY do not forward onwards from Transmit Queue until actual in Flights+this to be forwarded packet's data payload length becomes =<trackedCWND (or Allowed in Flights)/(1+curRTT in seconds−minRTT in seconds)

18. Methods as in accordance with claims 2 or 3 or 17 above, in said Methods:
Intercept Module does not immediately ‘spoof acks’ towards resident TCP whenever receiving new higher SeqNo packets from resident TCP, instead Intercept Module ‘spoof acks’ towards resident TCP ONLY when 3^{rd} DUPACK arrives from network (this 3^{rd} DUPACK will only be forwarded onwards to resident TCP after the ‘spoof ack’ has been forwarded first, with SpoofACKNo=3^{rd} DUPACKNo+data payload length of Packet Copies list entry with corresponding same SeqNo as 3^{rd} DUPACKNo), AND immediately ‘spoof NextAcks’ (ie NextAcks=packet's SeqNo+its data payload length) whenever any Packet Copies' SentTime+eg 850 ms<present systime (ie before RFC specified minimum lowest RTO Timeout value of 1 second triggers resident TCP's RTO Timeout retransmission), thus resident TCP now never ever notice any 3^{rd} DUPACK nor any RTO Timeout packet drop events whatsoever.

19. Methods as in accordance with claims 17 or 18 above, in said Methods:
Intercept Module does not ‘spoof ack’ whatsoever UNTIL very 1^{st} 3^{rd} DUPACK or RTO Timeout packet drop event is noticed by resident TCP, thereafter Intercept Module continues with ‘spoof acks’ schemes as described: thus resident TCP would only ever able to increment its own CWND linearly per RTT.

20. Methods as in accordance with claims 17 or 18 or 19 above, in said Methods:
the resident TCP source code is modified directly correspondingly thus not needing Intercept Module, and with many attending simplifications achieved

21. Methods as in accordance with claims 2 or 3 or 10-20 above, in said Methods the modifications are implemented at receiver side Intercept Module:
when receiver resident TCP initiates TCP establishment, receiver side Intercept Module records the negotiated max sender/receiver window size, max segment size, initial sender/receiver SeqNos & ACKNos & various parameters eg large scaled window option/SACK option/Timestamp option/No Delay ACK option.
receiver side Intercept Module records the very 1^{st} data packet's SeqNo (sender 1stDataSeqNo) & the very 1^{st} data packet's ACKNo (sender 1stDataACKNo)
when receiver resident TCP generates ACK/s towards remote sender TCP (whether pure ACK or ‘piggyback’ ACK), receiver side Intercept Software will modify the ACKNo field value to be Receiver1stACKNo (initialised to be same value as initial negotiated ACKNo) thus after receiving 3 such modified ACKs remote sender TCP will enter into fast retransmit phase & receiver side Intercept Module upon detecting 3^{rd} DUPACK forwarded to remote sender TCP will now generate an exact # of ‘pure’ multiple DUPACKs all with ACKNo field value set to same Receiver1stACKNo exact # of which=total in Flight packets (or trackedCWND/sender SMSS)/2, thus remote sender TCP upon entering fast retransmit phase here will have its CWND value ‘restored’ to the value just prior to entering fast retransmit phase & could immediately ‘stroke’ out 1 packet (new higher SeqNo packet or retransmission packet) for each subsequent arriving multiple same SeqNo Multiple DUPACKs preserving ACKs Clocking
receiver side Intercept Module upon detecting/receiving retransmission packet from remote sender TCP (with SeqNo=<recorded largest ReceivedSeqNo) and while at the same time remote sender TCP is not in fast retransmit mode (ie this now correspond to remote sender TCP RTO Timeout retransmit) will similarly generate an exact required # of ‘pure’ multiple DUPACKs all with ACKNo field value set to same Receiver1stACKNo exact # of which=total in Flight packets (or trackedCWND/sender SMSS)/(1+curRTT in seconds−minRTT in seconds) THUS ensuring remote sender TCP's CWND value upon completing RTO Timeout retransmission is ‘RESTORED’ immediately to ‘Calculated Allowed in Flights’ value in packets (or in equivalent bytes) ensuring complete removal of all nodes' buffered packets along the path & subsequent total in Flights ‘kept up’ to the new ‘Calculated Allowed in Flights’ value: OPTIONALLY receiver side Intercept Module may want to subsequently now use this received RTO Timeout retransmission packet's SeqNo+its datalength as the new incremented Receiver1stACKNo/new incremented ‘clamped’ ACKNo.
After the 3^{rd} DUPACK has been forwarded to remote sender TCP triggering fast retransmit phase, subsequently receiver side Intercept Module upon detecting receiver resident TCP generating a ‘new’ ACK packet (with ACKNo>the 3^{rd} DUPACKNo forwarded which when received at remote sender TCP would cause remote sender TCP to exit fast retransmit phase again reducing CWND to Ssthresh value of CWND/2) will now generate an exact # of ‘pure’ multiple DUPACKs all with ACKNo field value set to same Receiver 1stACKNo
exact # of which=[{total in Flight packets (or trackedCWND in bytes/sender SMSS in bytes)/(1+curRTT in seconds−minRTT in seconds)}−total in Flight packets (or trackedCWND in bytes/sender SMSS in bytes)/2]
ie target in Flights or CWND in packets to be ‘restored’ to—remote sender TCP's halved CWND size on exiting fast retransmit (or various similar derived formulations) THUS ensuring remote sender TCP's CWND value upon exiting fast retransmit phase is ‘RESTORED’ immediately to ‘Calculated Allowed in Flights’ value in packets (or in equivalent bytes) ensuring complete removal of all nodes' buffered packets along the path & subsequent total in Flights ‘kept up’ to the new ‘Calculated Allowed in Flights’ value: OPTIONALLY receiver side Intercept Module may want to subsequently now use this ‘new’ ACKNo as the new incremented Receiver 1stACKNo/new incremented ‘clamped’ ACKNo.
OPTIONALLY instead of forwarding each receiver resident TCP generated ACK packets modifying their ACKNo field values to all be the same Receiver1stACKNo/‘clamped’ ACKNo receiver side Intercept Module can only forward 1 single ACK packet only when the cumulative # of bytes freed by the receiver resident TCP generated ACK/s becomes near equal to or near to exceed the initial negotiated remote sender TCP max segment size, and subsequently receiver side Intercept Module will thereafter sets Receiver1stACKNo/‘clamped ACKNo’ to be this latest forwarded ACKNo . . . & so forth in repeated cycles
Upon detecting that the total # of ‘bytes’ remote sender TCP has been progressively cumulatively incremented (each multiple DUPACKs increments remote sender TCP's CWND by 1*SMSS) getting close to (or getting close to eg half . . . etc) the remote sender TCP's negotiated max window size, receiver side Intercept Software will thereafter always use this present largest received packet's SeqNo from remote sender (or SeqNo+its datalength) as the new incremented Receiver1stACKNo/‘clamped’ ACKNo
OPTIONALLY receiver side Intercept Module upon detecting 3 new packets with out-of-order SeqNo have been received from remote sender TCP, to then thereafter always use the ‘missing’ earlier SeqNo as the new incremented Receiver1stACKNo/‘clamped’ ACKNo
Allowed in Flights & trackedCWND values are updated constantly, receiver side intercept Module may generate ‘extra’ required # of pure multiple DUPACKs to ensure actual in Flights ‘kept up’ to Allowed in Flights or trackedCWND value
OPTIONALLY ‘Marker’ packets CWND/in Flights tracking techniques, ‘continuous advertised receiver window size increments’ techniques, Divisional ACKs techniques, ‘synchronising packets’ techniques, inter-packet-arrivals techniques, receiver based ACKs Pacing techniques could be adapted incorporated

22. Methods as in accordance with claim 21 above, in said Methods:
the receiver resident TCP source code is modified directly correspondingly thus not needing receiver side Intercept Module, and with many attending simplifications achieved

23. Methods as in accordance with any of claims 2 or 3 or 10-22 above, in said Methods:
All, or majority of all TCPs within proprietary LAN/WAN/geographic subset all implements the methods/modifications thus achieving better TCP throughput/latency performances.
Further all TCPs or majority of all TCPs within proprietary LAN/WAN/geographic subset all ‘refrain’ from any increment of Calculated Allowed in Flights or trackedCWND or CWND even when latest arriving curRTT (or curOTT)<minRTT (or minOTT)+‘tolerance variance’ eg 25 ms+‘refrain buffer zone’ eg 50 ms THEN PSTN or close to PSTN real time guaranteed transmission qualities will be achieved for all TCP flows within the within proprietary LAN/WAN/geographic subset
OPTIONALLY when latest arriving curRTT (or curOTT)<minRTT (or minOTT)+‘tolerance variance’ eg 25 ms+‘refrain buffer zone’ eg 50 ms THEN TCPs may again resume increments of Calculated Allowed in Flights or trackedCWND or CWND

24. Methods as in accordance with any of claims 2 or 3 or 10-23 above, in said Methods:
In any of the Methods the component method/component step therein may be replaced by any of other Methods' component method/component sub-method/component step/component sub-step, and in any of the Methods combinations of other Methods' component method/component sub-method/component step/component sub-step may be added adapted incorporated.
